(19) United States
(12) Patent Application Publication
(10) Pub. No.: US 2018/0060584 A1
(43) Pub. Date: Mar. 1, 2018

(54) Securing Code Execution in a Network Environment

(71) Applicant: Sunny Ahuwanya, Washington, DC (US)

(72) Inventor: Sunny Ahuwanya, Washington, DC (US)

(21) Appl. No.: 15/253,891

(22) Filed: Sep. 1, 2016

(51) Int. Cl. G06F 21/56; G06F 21/62; G06F 21/57

(52) U.S. Cl. CPC G06F 21/566; G06F 21/577; G06F 21/6218

(57) ABSTRACT

Systems and methods for restricting code execution to a subset of language, runtime and instruction set capabilities. The subset of capabilities is preselected or inferred to ensure safety and stability. Furthermore, code execution can be monitored to guarantee the execution runs within the expected boundaries. By restricting execution to a safe subset of operations in a monitored or constrained execution environment, untrusted programs can be executed without the risk of adverse effects on the computing device or its software or network environment. Embodiments of the claimed subject matter can target various languages, runtime systems, platforms, and hardware.

### BACKGROUND

Historically, there has been a need for computer systems to execute computer programs received from external sources, while preventing the untrusted computer programs from causing any harm to the computer system or its network. Various schemes and solutions have been proposed and developed to address this issue, most of which involve scanning the computer programs for pre-identified patterns that may indicate malware. However, this trust model does not prevent malicious code that has not yet been cataloged from being executed.

The rise of mobile devices and cloud services has amplified the need to safely execute untrusted, perpetually updated, third party applications and code received over a network. The existing trust models will not sufficiently keep up with the demand for safe execution of a plethora of untrusted but otherwise potentially useful code.

Some computing environments need to verify programs that were not necessarily received from external sources, to guarantee their integrity and to ensure they function within certain boundaries. In some other environments and platforms, arbitrary code is required to be executed without causing any instability or security issues to the platform or environment.

There have been various efforts to provide safer execution models with stronger safety guarantees, but they are either too specific to a particular runtime or operating system, depend on an unreliable or impractical trust model, or require elaborate setups and configurations to function. Some of the relevant conventional systems are discussed briefly below.

U.S. Pat. No. 5,974,549 describes a system in which programs can be executed in a secure manner. It however requires injecting a security monitor into a host application, which may not be feasible for some solutions, security model restrictions, platforms or operating systems.

U.S. Pat. No. 6,351,816 describes a system to secure code execution but is limited to Java® servlet technology, and relies on digital signatures and the origin of the code to determine the degree to which the code is trusted.

U.S. Pat. No. 8,745,361 describes a system by which auxiliary code can be executed in an isolated manner. However, it can only detect abnormal behavior after the undesired execution has taken place, requires the use of an application domain, and is limited to plug-in management server applications running in a corporate hosted environment.

U.S. Pat. Nos. 8,424,082 and 9,058,483 describe systems to safely execute an untrusted code module but they operate at the native instruction level and may not be able to validate higher level constructs. They also cannot perform finer-grained verifications such as permitting access to a network application layer, while forbidding access to lower layers such as direct access to sockets.

Some conventional proposals involve using containerization and virtualization technologies where each execution is sandboxed in a virtual machine or container. However, these approaches make for solutions that are not portable, tedious to set up, and exhibit performance and interoperability issues.

Some conventional proposals rely on sandboxing features present in the runtime system. These approaches are inflexible in the level of scrutiny applied during verification. For example, these approaches are unable to block arbitrary disk access while allowing use of an identified disk access library that performs disk access safely. Furthermore, these approaches are defenseless against vulnerabilities and security flaws in the runtime system.

Some conventional proposals involve restricting delivery of applications from a centralized app store, allowing applications to be vetted before users are permitted to download and install them. In this scheme, an application can also be quickly delisted from the app store and removed remotely from connected devices, if it's identified to be malicious. However, this approach is flawed because clever malicious applications can appear normal, get approved and installed by millions of users before any malicious activity is noticed. A malicious application would have caused a lot of harm before being removed from the app store and devices. Furthermore, the malicious application may act very surreptitiously and may never be detected.

Accordingly, it is desirable to avoid these and other related problems. It is desirable to have a safe execution security model that can validate previously unknown programs, is not tied to features specific to any operating system or platform, is easy to deploy, does not depend on virtualization or containerization technology and is applicable to various programming languages, code formats, and runtime systems.

### SUMMARY

One embodiment comprises: an execution environment that receives code, performs any needed compilations or processing on the code, and executes the code; an identified or inferred set of prohibited operations that should not be executed; an analysis subsystem for analyzing code and detecting use of prohibited operations; and communicating code analyzed by the analysis subsystem, to the execution environment for processing.

One embodiment comprises: an execution environment that receives code, performs any needed compilations or processing on the code, and executes the code; a security action to be performed when the execution environment exhibits erroneous behavior that puts at risk the operational safety of the executing environment; and monitoring execution environments for erroneous behavior, and performing the security action, if erroneous behavior is detected.

One embodiment comprises: an execution environment that receives code, performs any needed compilations or processing on the code, and executes the code; an identified or inferred set of prohibited operations that should not be executed; an analysis subsystem for analyzing code and detecting use of prohibited operations; a security action to be performed when the execution environment exhibits erroneous behavior that puts at risk the operational safety of the executing environment; communicating code analyzed by the analysis subsystem, to the execution environment for processing; and monitoring execution environments for erroneous behavior, and performing the security action, if erroneous behavior is detected.

One embodiment comprises: an execution environment that receives code, performs any needed compilations or processing on the code, and executes the code; an identified or inferred set of prohibited operations that should not be executed; and performing code analysis in the execution environment to detect use of prohibited operations.

### BRIEF DESCRIPTION OF THE FIGURES

FIG. 1 illustrates a high level overview of an embodiment that comprises one or more analysis subsystems, one or more execution environments and a monitoring subsystem.

FIG. 2 illustrates an exemplary code execution software component and the computer memory it accesses.

FIG. 3 illustrates an exemplary execution environment.

FIG. 4 illustrates an exemplary analyzer software component.

FIG. 5 illustrates an exemplary analysis subsystem.

FIG. 6 illustrates an exemplary monitoring subsystem monitoring an execution environment.

FIG. 7 illustrates an example implementation of using a list of constructs to check for prohibited operations.

FIG. 8 illustrates an example implementation of using heuristics to check for the possibility of the presence of prohibited operations.

FIG. 9 illustrates an example implementation of rewriting code to a safer form.

FIG. 10 illustrates an example implementation of compiling code to a lower level representation and analyzing the lower level representation for prohibited operations.

FIG. 11 illustrates an example implementation of a Security Policy Decision.

FIG. 12 illustrates an example implementation of a custom memory allocator.

FIG. 13 illustrates an exemplary computer system.

FIG. 14 illustrates a high level overview of an embodiment that comprises an analysis subsystem and an execution environment.

FIG. 15 illustrates a high level overview of an embodiment that comprises an execution environment and a monitoring subsystem.

FIG. 16 illustrates an embodiment that is set up to function within a single operating system process.

FIG. 17 illustrates an embodiment that spans multiple machines and operating system processes.

### DETAILED DESCRIPTION

Disclosed herein are systems and methods of restricting code execution to a safe subset of language, runtime, and instruction set capabilities. The present disclosure is applicable to a wide variety of programming languages, code formats, runtime systems, platforms, operating systems, and hardware.

One embodiment of the present disclosure provides a method to perform safe execution on a computing device. During operation, the code, which may be in a high, intermediate, or low level language, is received. The code undergoes a verification process where it is analyzed to confirm that only permitted operations are present in the code. The verification process includes inspecting operations in the code and determining if each inspected operation is prohibited or permitted. The verified code is loaded into an execution environment which is constrained to limit unbounded behavior during execution. The code is then executed in the execution environment. The execution is monitored for erroneous behavior. A security action such as halting execution can be performed if the execution behaves in an erroneous manner. By restricting execution to a safe subset of operations in a monitored and constrained execution environment, untrusted programs can be executed without the risk of adverse effects on the computing device or its software, network, or host environment.

In some embodiments, a preselected or inferred list of permitted operations is referenced during the verification process to determine if a given operation is permitted.

In some embodiments, code compilations, transformations, or other processing may occur before the code is executed.

In some embodiments, verification of permitted operations occur in real time, during execution.

In some embodiments, the code may be modified to improve safety, security or stability during execution.

In some embodiments, access to runtime and system resources during execution is restricted or moderated by the execution environment or by the monitoring subsystem.

In some embodiments, the code is not analyzed before execution.

In some embodiments, execution is not monitored for erroneous behavior.

In some embodiments, multiple executions can occur simultaneously, isolated from each another, using process boundaries or process partitioning mechanisms as a method of isolation.

In some embodiments, the execution environment may use conventional sandboxing, virtualization, or containerization techniques as a method of isolating executions.

Embodiments of the present disclosure can be set up to function as a single operating system process and thus easily packaged as a portable solution, requiring minimal setup on the host computer. Embodiments of the present disclosure can also be set up as distributed systems that span many physical or virtual machines, which may be more suitable for a software as a service (SaaS) or cloud solution.

Systems and methods in accordance with the present disclosure offer verification of operations at different levels of granularity. Higher level operations may be permitted while lower level operations are blocked and vice versa.

The present disclosure provides systems and methods to safely execute arbitrary code or to verify that a program will run within some predefined boundaries.

The present disclosure is not tied to operating system specific features or to sandboxing features provided by an operating system, virtualization, or containerization provider. This makes it applicable to a wide range of languages, platforms, hardware, and deployment targets.

Systems and methods in accordance with the present disclosure can be used in securing the delivery of mobile applications, either by verifying the applications at the point of submission to an app store, or during installation and execution on the device.

Technologies that deliver native application experiences to devices, without requiring an installation, can use systems and methods in accordance with the present disclosure to provide secure decentralized delivery of software.

As used herein, the term “code” may refer to computer program code, scripts, and snippets in high level, intermediate level, and low level languages, including source code, object code, bytecode, intermediate language code, intermediate representation, low level language code, assembly language code, and machine code. The term “code” may also refer to code in pseudo-languages, non-Turing complete languages, general purpose languages and domain specific languages, such as LaTeX, reStructuredText, Lingo, AppleScript®, Scratch®, LabVIEW®, MATLAB®, Coq®, SQL, CSS and XSLT. The term “code” may also refer to a set of logical files in various languages and formats, including linked libraries and binaries, and ancillary files that may not contain executable code.

As used herein, the term “prohibited operation” is an operation that is disallowed or restricted, and may refer to a single instruction, a combination of instructions, or one or more instructions encountered under certain conditions. Such instructions include access to types, field access, function calls, method calls, access to packages, access to namespaces, use of language keywords and syntax, use of runtime and system capabilities, and use of operations, opcodes and other kinds of instructions.

As used herein, the term “permitted operation” is an operation that is allowed or unrestricted, and may refer to a single instruction, a combination of instructions, or one or more instructions encountered under certain conditions. Such instructions include access to types, field access, function calls, method calls, access to packages, access to namespaces, use of language keywords and syntax, use of runtime and system capabilities, and use of operations, opcodes and other kinds of instructions.

As used herein, the term “erroneous behavior” refers to behavior that puts at risk the safety, security, stability, reliability, robustness, responsiveness or performance of the software system, or its host or network environment. Such behavior include behavior that weaken security, consume an excessive amount of resources, or disrupts the activities of other processes, users or agents in the embodiment, containing systems, host or network environment.

As used herein, the term “operational safety” refers to the safety and performance of a system, including its security, stability, reliability, robustness or responsiveness.

As used herein, the term “host environment” refers to the computing environment where a software system is hosted. Host environments include, but are not limited to, a hardware device, an operating system, a virtual machine, a container, a collection of software running on a computer, a collection of software running on a network, a web host, a server, a Software as a Service platform, and a cloud computing platform.

One embodiment has four general arrangements, from which elements from constituent components may be combined to devise various other embodiments. The first arrangement comprises an analysis subsystem and an execution environment. The second arrangement comprises an execution environment and a monitoring subsystem. The third arrangement comprises an analysis subsystem, an execution environment, and a monitoring subsystem. The fourth arrangement comprises an execution environment.

To ensure that only permitted operations are executed, some embodiments perform code analysis either before executing code or in real time as code is being executed, or both.

Some embodiments monitor the execution to ensure that executing code behaves as expected.

An embodiment may employ conventional sandboxing mechanisms as an additional layer of security.

The components in one embodiment, which include the analysis subsystem, execution environment and monitoring subsystem can be set up to function in a single operating system process, or can be set up to operate as separate cooperating operating system processes, running on the same computer system, or spanning several computers. In addition, multiple instances of each component can run on the same computer system or distributed across many computer systems.

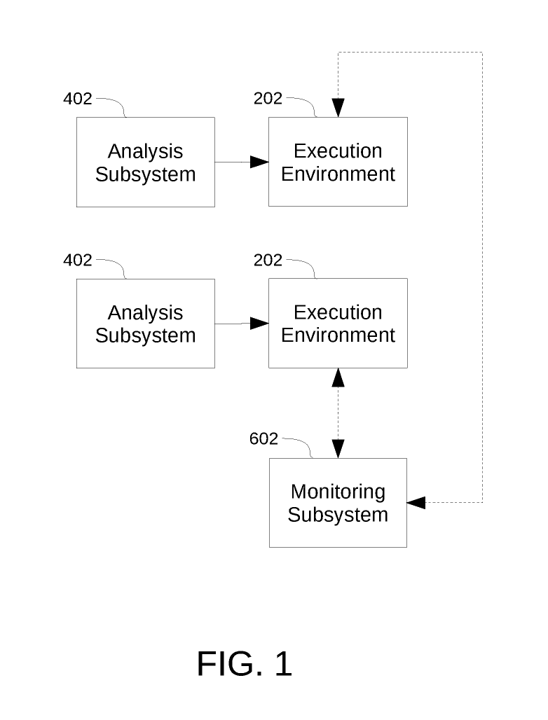

FIG. 1 is a diagram which illustrates an overview of an embodiment that comprises one or more analysis subsystems 402, one or more execution environments 202 and a monitoring subsystem 602.

From a high level perspective, an analysis subsystem 402 receives code, analyzes it, and if no prohibited operation was detected, transfers the analyzed code to an execution environment 202 for execution. The monitoring subsystem 602 monitors the execution environments 202 to ensure execution runs within the expected boundaries. Multiple analysis subsystems 402 and execution environments 202 are present to offer concurrent analysis and execution of multiple code instances.

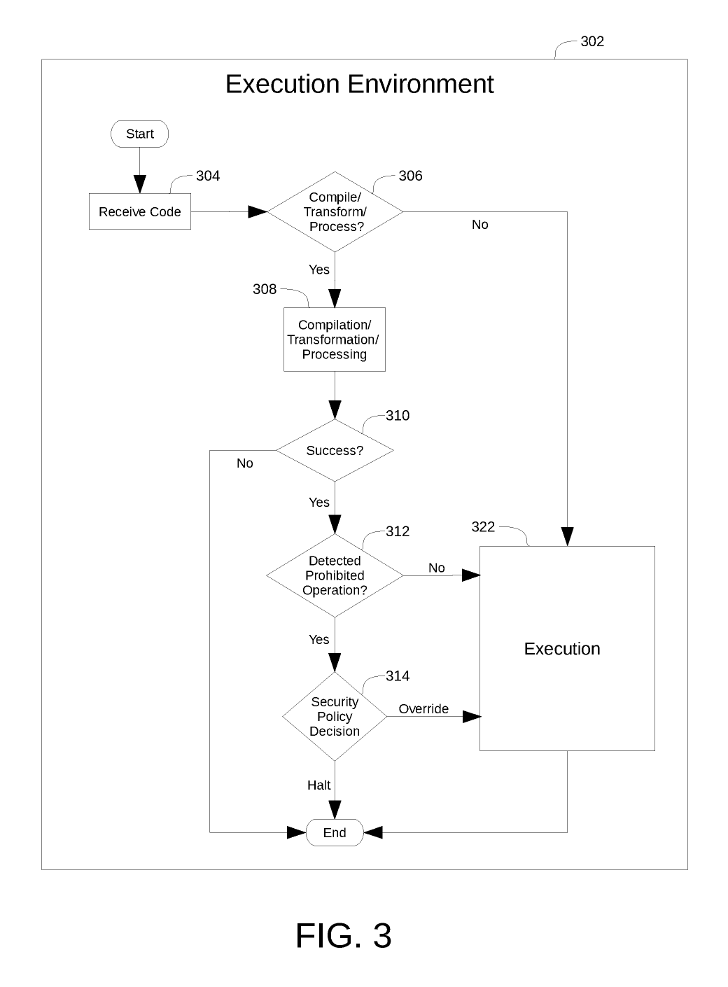

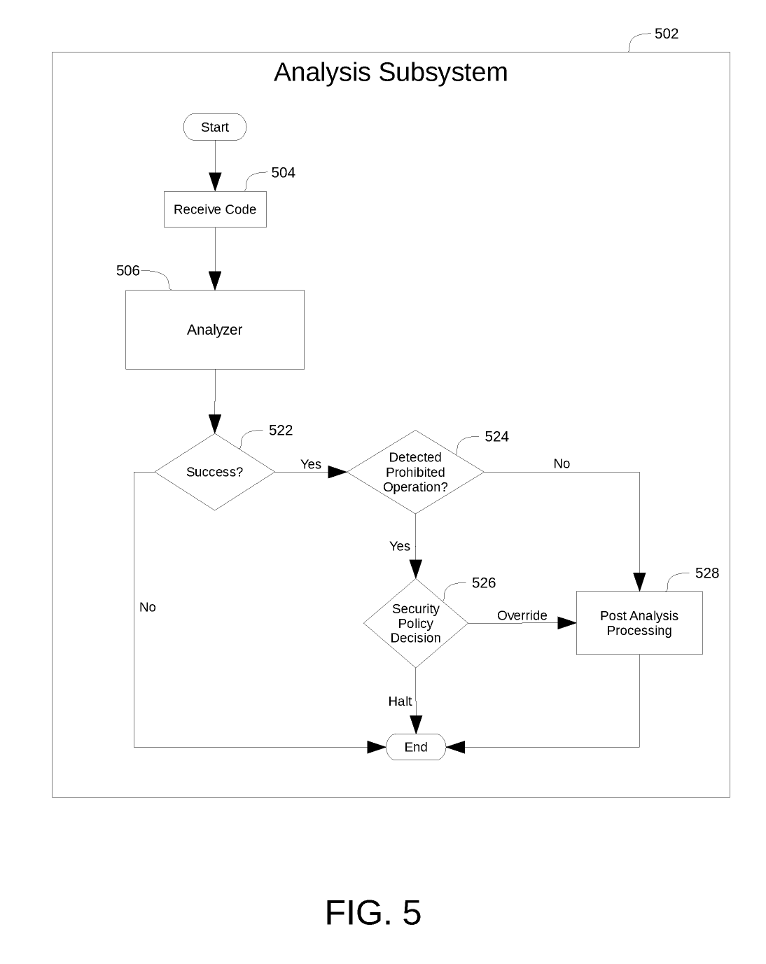

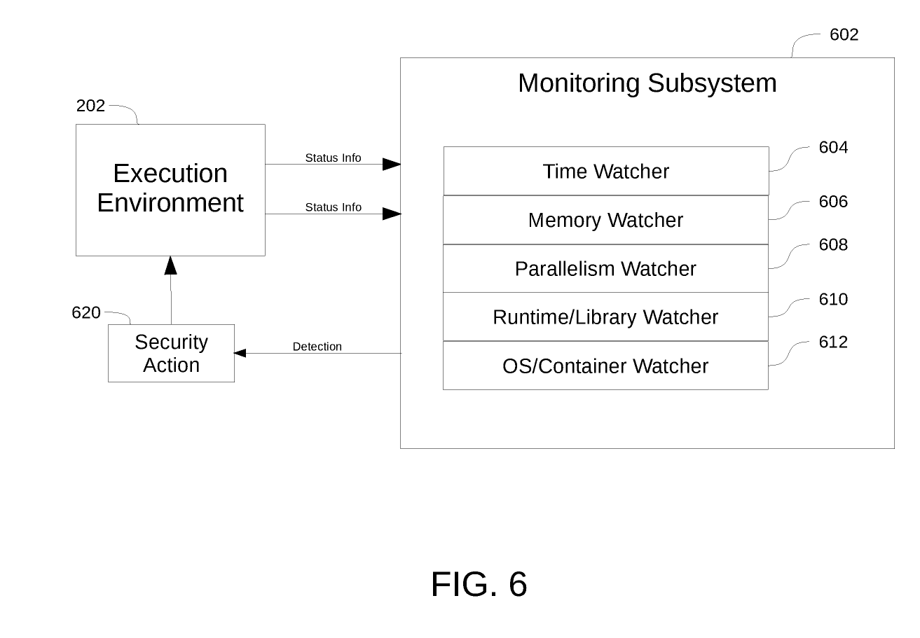

Exemplary implementations of an execution environment 202, analysis subsystem 402 and monitoring subsystem 602 are illustrated in FIG. 3, FIG. 5 and FIG. 6 respectively, and are also described in more detail later in the specification.

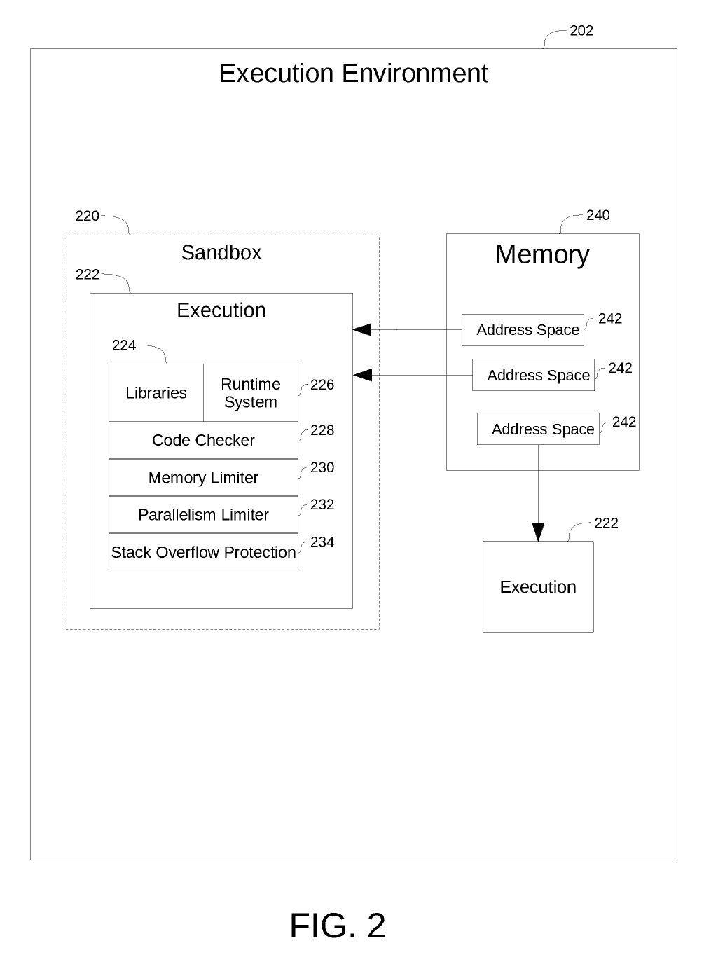

FIG. 2 is a diagram which illustrates an exemplary code execution software component 222 and the computer memory 240 it accesses.

The execution environment component 202 is the containing software system that performs the steps in the execution environment 302, as illustrated in FIG. 3 and described later.

The code execution software component 222, also known as the execution component 222 for short, is used by the execution step 322 of an execution environment 302, to execute code.

In the execution component 222, code is executed against linked libraries 224 and the runtime system 226. The linked libraries 224 may be a combination of libraries referenced by the code, provided by the runtime system, and libraries provided by the execution component 222 itself.

The execution component 222 may employ a conventional sandbox 220 to provide an extra layer of security.

The sandbox 220 may operate at the operating system level. Examples of sandboxes that operate at the operating system level include virtualization technology such as virtual machines or containerization technology such as kernel namespaces, chroots, CGroups (control groups) and Seccomp.

The execution component 222 may also be sandboxed 220 by using operating system features that limit the resources a process can access. Examples include using the setrlimit and prlimit system calls to set resource limits in Linux®, or using the SetInformationJobObject Win32® function to set limits to job objects in Windows®.

The sandbox 220 may operate at the runtime system level. For instance, using the sandboxing features provided by .NET's AppDomain class, or the JRE's ProtectionDomain, ClassLoader and SecurityManager classes.

Multiple sandboxes 220 could be employed at different levels by the execution component 222.

The execution component 222, may elect to have any or all of the following subcomponents in use during execution: a code checker 228, a memory limiter 230, a parallelism limiter 232 and stack overflow protection 234. These sub-components may function independently or may be integrated as sub modules of the linked libraries 224 or the runtime system 226.

The code checker 228 is an optional sub-component that checks for prohibited operations as the code is being executed. This sub-component can act in lieu of an analysis subsystem 502 which is described later, or can act as an extra safety check. This sub-component is helpful in detecting prohibited operations that are difficult to detect during pre-analysis. For example, dynamic operations and types cannot easily be resolved by static analysis, however, at run time, the resolved operation or type can be crosschecked against a blacklist or whitelist of operations at the call site. This sub-component may be used to detect prohibited operations that are conditional on actions that can only be observed at run time. For example, prohibiting network access once a large number of contact information has been read from a device's contact list. The sub-component may also enforce restrictions in the execution environment component 202. For example, it could keep a count of the number of active threads as they are created and refuse to create new threads once a threshold has been reached.

One approach to prevent execution of prohibited operations is to perform execution 222 against a version, custom build or configuration of the runtime system 226 or linked libraries 224 where prohibited operations have been removed, made inaccessible, or modified to be unworkable or with restricted capabilities. An example is modifying a prohibited function to throw an exception when called. Operations that can potentially cause instability may be modified to limit their capabilities. For instance, an operation that increases the level of parallelism may be modified to function as expected if a parallelism level threshold has not been reached, and otherwise cause an error to occur once the threshold has been reached. This approach can be used in lieu of or in addition to a code checker 228.

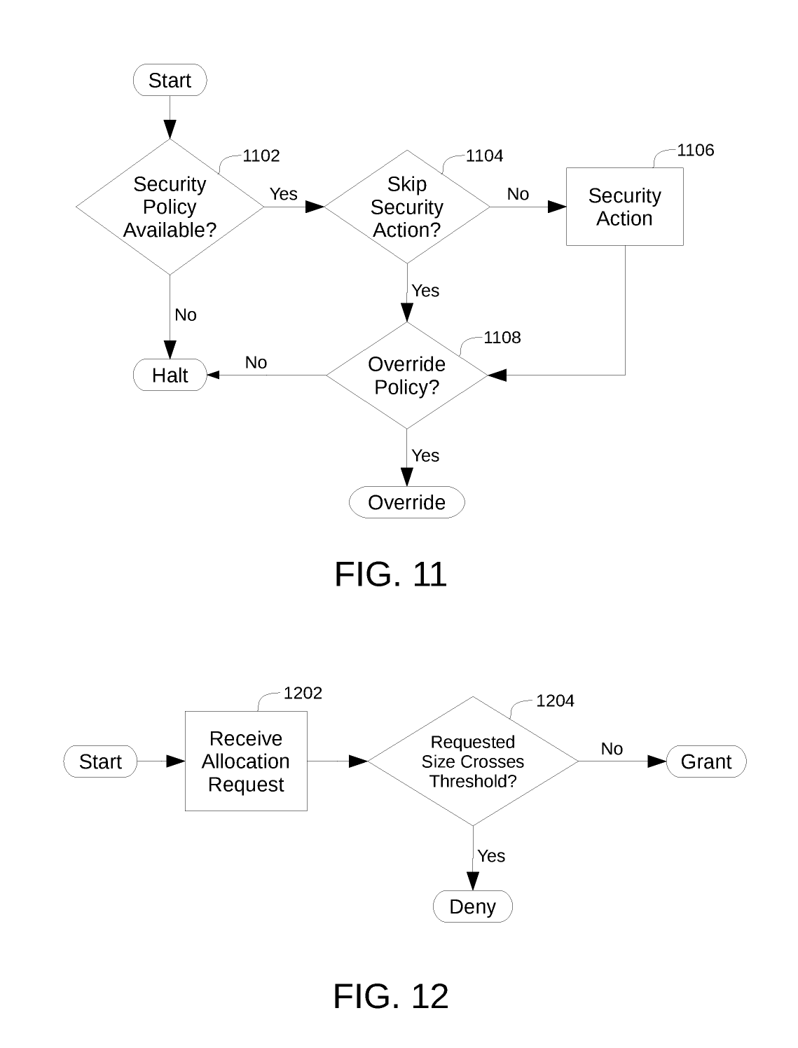

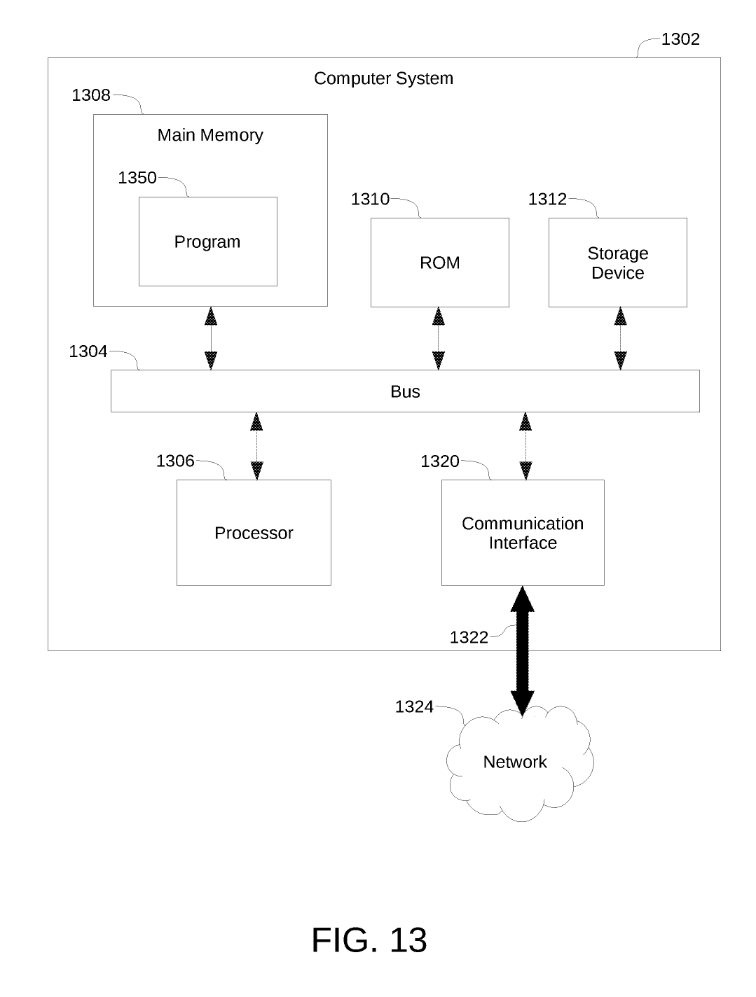

The memory limiter 230 is an optional sub-component that prevents executing code from consuming more than an allotted amount of memory. This sub-component may be implemented by using operating system sandboxing and resource limiting features, virtualization or containerization technology such as a memory CGroup. This sub-component may be implemented by modifying the runtime and setting a limit to the amount of consumable memory. This sub-component may also be implemented by providing a custom memory allocator in the runtime system or runtime host, for example in a CLR host for .NET. An example of a custom memory allocator is illustrated in FIG. 12 and is described later in the specification.

An embodiment may elect to not implement a memory limiter 230 and instead rely on a monitoring subsystem 602 to detect excessive memory usage.

The parallelism limiter 232 is an optional sub-component that prevents executing code from having an excessive level of parallelism in the form of threads, child-processes or other parallelism constructs. This sub-component may be implemented by using operating system sandboxing and resource limiting features, virtualization or containerization technology such as a cpu CGroup. This sub-component may be implemented by modifying the runtime and setting a limit to the permitted level of parallelism. This sub-component may be implemented by providing custom thread managers that limit concurrency such as custom Executors in Java or a custom Task Scheduler in .NET. This sub-component may be implemented by prohibiting constructs in code that increase the degree of parallelism, such as the go keyword in the Go programming language.

An embodiment may elect to not implement a parallelism limiter 232 and instead rely on a monitoring subsystem 602 to detect excessive levels of parallelism.

The stack overflow protection sub-component 234 is an optional sub-component that prevents a call stack overflow from halting or terminating the O.S. process. This sub-component may be implemented by modifying the runtime to check for stack space during execution. This sub-component may be implemented by providing a custom runtime host, such as a custom CLR host set up to not terminate the O.S. process when a stack overflow is encountered by the runtime system.

An embodiment may elect not to implement a stack overflow protection sub-component 234 if the runtime can recover gracefully from a call stack overflow. An embodiment may also elect not to implement this sub-component if the execution component 222 is the sole tenant of an O.S. process, in which case, termination of the execution component 222 has no adverse effect on other execution environments.

The execution component 222 accesses memory 240 for use during execution. Address spaces 242 within available memory are allocated by the runtime and/or operating system for use during execution. The memory address spaces 242 allocated for an execution component 222 should not be accessible by another execution component 222 running in the same or different execution environment component 202, in order to prevent an execution from reading or modifying the memory contents of another execution. This occurs automatically for embodiments where executions are sole tenants of the containing O.S. process and the operating system offers memory protection.

In embodiments where an O.S. process can host multiple execution environment components 202, a process partition, such as an AppDomain in .NET or a Protection Domain in Java should be used to isolate executions, thereby preventing memory in use by an execution 222 from being accessible by another execution 222 within the same process.

FIG. 3 is a flow diagram which illustrates an exemplary execution environment 302.

The execution environment 302 receives code via an interface. The code may be received 304 via a program function, memory access, a storage device, a database, a network interface or service, intra and inter-process communication mechanisms.

If the code requires compilation, transformation or some other pre-execution processing (306 “Yes” branch), then the code is compiled, transformed or processed 308.

If the code does not require compilation, transformation or some other pre-execution processing (306 “No” branch), then the code is forwarded to the execution step 322.

The execution step 322 performs code execution using a code execution software component 222 as described earlier and illustrated in FIG. 2.

Examples of compilation, transformation, or pre-execution processing 308 include, but are not limited to, compiling code to a lower level code or machine code, linking, creating an abstract syntax tree, creating a symbol table, checking for errors in the code, checking for prohibited operations in the code, converting or transpiling code from one language to another language and/or from one format to another format, processing configurations, and copying code from one memory or storage location to another.

If the compilation, transformation or pre-execution processing 308 did not succeed (310 “No” branch), for example due to errors in the code, then the code is not forwarded for execution.

If the compilation, transformation or pre-execution processing 308 did not detect any prohibited operations or does not have the capability to detect prohibited operations or is not configured to detect prohibited operations (312 “No” branch), then the compiled, transformed or processed code is forwarded to the execution step 322.

If the compilation, transformation or pre-execution processing detected one or more prohibited operations (312 “Yes” branch), a Security Policy Decision is made 314, which may include executing a predetermined security action or stopping the execution (314 “Halt” branch).

A Security Policy Decision 314 may elect to forward the code for execution (314 “Override” branch). An example Security Policy Decision is illustrated in FIG. 11 and is described in more detail later in the specification.

Examples of the detection of prohibited instructions during compilation, transformation or pre-execution processing include, but are not limited to:
a. Detecting restricted operations in the form of compiler diagnostic reports. For instance, a C# compiler reporting unsafe context or the Go language compiler reporting use of non local imports.
b. Pre and post build tasks that detect prohibited operations on either the source or output.
c. A linter or analyzer software component that runs pre or post build, or during compilation, to detect prohibited operations.
d. A compiler configured or customized to detect prohibited operations during compilation.

An embodiment may customize a compiler to perform checks for prohibited operations, during compilation or could use built in compiler extension features, if available, such as the Compiler Plugins feature available in the Rust programming language.

An embodiment may compile code in a high level language such as C#, VB.NET, F#, Java, Scala, Kotlin®, Rust, Swift®, C or C++ into an intermediate or low level language, such as .NET CIL, Java bytecode or LLVM® IR. The output intermediate or low level language code is analyzed for use of prohibited operations. This embodiment is thus able to support many languages without needing a special analyzer for each language. The analysis may be performed using analysis libraries such as Mono.Cecil for .NET CIL, ASM or BCEL for Java bytecode, and the IRReader class of the LLVM project for LLVM IR.

One approach to perform the analysis is to decompile or disassemble the intermediate or low level code into a higher level representation and analyze the higher level representation using higher level language analysis libraries and tools.

An embodiment may perform analysis on libraries, modules and other code referenced by the code, to ensure that callable routines in the linked libraries, modules and code do not contain prohibited operations. This analysis may occur at the same time the code is analyzed or at the point when the library, module or other code is loaded for execution.

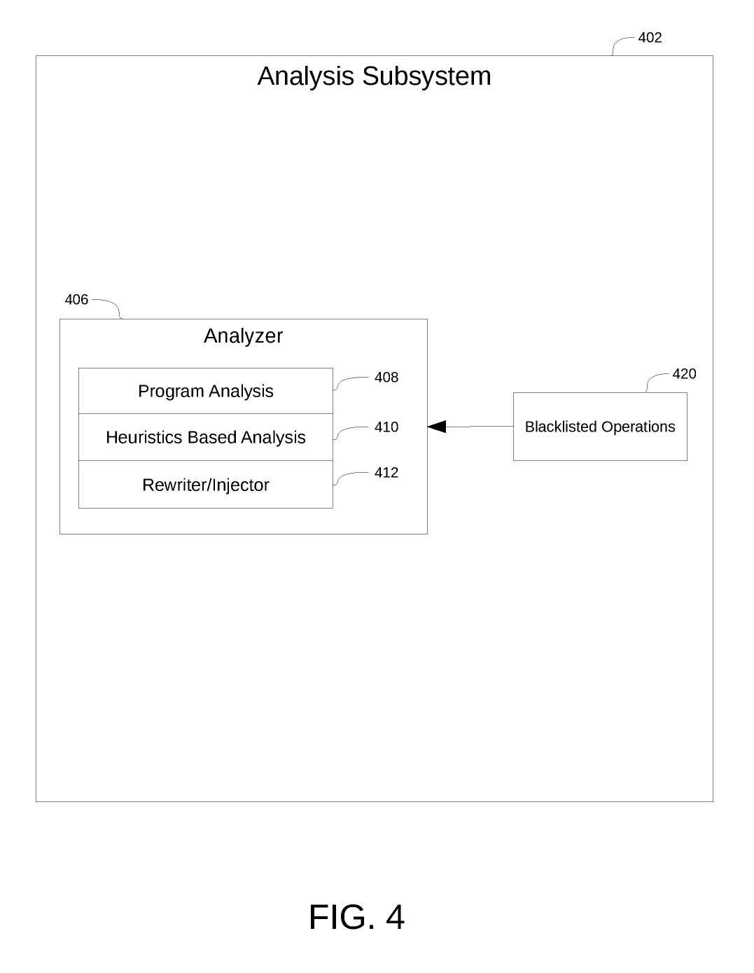

FIG. 4 is a diagram which illustrates an exemplary analyzer software component 406 and the dictionary of blacklisted operations 420 it consults.

The analysis subsystem component 402 is the containing software system that performs the steps in the analysis subsystem 502, as illustrated in FIG. 5 and described later.

The analyzer software component 406, also known as analyzer 406 for short, is used by the analyzer step 506, of an analysis subsystem 502, to analyze code and detect use of prohibited operations.

The analyzer 406 may elect to have any or all of the following sub-components in use during analysis: a program analysis sub-component 408, a heuristics based analysis sub-component 410 and a rewriter/injector sub-component 412.

The analyzer 406 and its sub-components may refer to a dictionary of blacklisted operations 420 to determine if a given operation is permitted.

The program analysis sub-component 408 is an optional sub-component that uses static and dynamic program analysis techniques to discover and detect prohibited operations.

Examples of libraries that may be utilized to analyze code include: Clang for C and C++; the IRReader class of the LLVM project for LLVM IR; Jalangi2 and Closure Compiler for JavaScript; Mono.Cecil and the .NET Compiler Platform (codename Roslyn), for .NET; Intend® IDEA, ASM and BCEL for Java; package parser for the Go programming language; the Parsing, Semantic Analysis and SIL generation components of the Swift compiler, for Swift; and the Parsing, HIR and MIR generation components of the Rust compiler, for Rust.

Examples of tools and libraries that may be used to analyze Android® application .dex or .apk format files include Dare, a Dalvik® retargeting tool or dex2jar, both of which can be used to convert the dex or apk files to Java class files. The output class files may then be analyzed using Java bytecode analysis libraries and tools.

Executable file such as ELF and PE file formats files can also be analyzed using disassembly and parsing tools and libraries such as GNU® Binutils.

One approach to analyze code in intermediate or low level language is to decompile or disassemble code into a higher level representation and analyze the higher level representation using higher level language analysis libraries and tools.

The heuristics based analysis sub-component 410 is an optional sub-component that uses heuristics and/or fuzzy logic to inspect code that may be difficult to analyze using program analysis techniques, to determine the likelihood that prohibited operations are in use.

An example of such heuristics based analysis is scanning strings in the code for the presence of executable code, in languages or platforms that permit dynamic evaluation of code. A more sophisticated implementation may attempt to refactor instances of dynamic code evaluation into other language constructs that can be statically analyzed.

A different example of a heuristics based analysis sub-component 410 is illustrated in FIG. 8 and is described later in the specification.

The rewriter/injector sub-component 412 is an optional sub-component that is used to inject code or modify existing code to improve operational safety during code execution. An example of such injected code is inserting code that check for ample stack space to prevent call stack overflows, in functions. This sub-component may be used to replace a prohibited operation with a safe alternative. This sub-component may be used to replace access to a restricted system resource such as a network interface, with a substitute operation that accesses the restricted system resource in a safe manner.

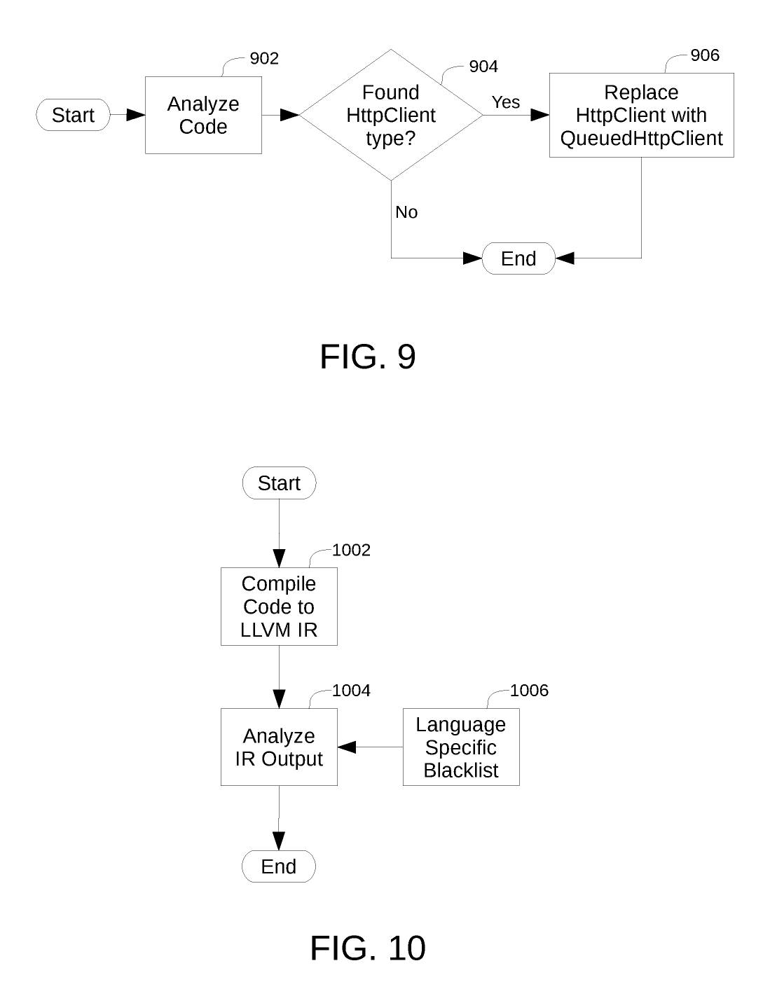

An example of a rewriter/injector sub-component 412 that rewrites access to the network is illustrated in FIG. 9 and is discussed later in the specification.

Beyond performing program and heuristics-based analysis for prohibited operations, the analyzer 406 may detect operations that can destabilize the runtime system 226. An example of such an operation is code that may tie up or disrupt a finalizer thread in a garbage-collected runtime system.

The dictionary of blacklisted operations 420 may contain types, functions, operations, language keywords, namespaces, packages, and other language and runtime operations. The analyzer 406 and its sub-components perform lookups against the dictionary of blacklisted operations 420 to determine if a given operation is prohibited.

The dictionary 420 may reside in memory, on disk, on a local machine, or in a remote system or database.

This dictionary 420 may be a whitelist instead of a blacklist, in which case the lookup logic is inversed and operations found within the dictionary are permitted. The dictionary 420 may also be a mix of blacklisted and whitelisted items. Items in the blacklist (or whitelist) should be chosen carefully to ensure all effectively permitted operations are safe and will not cause any disruptions, no matter how they are used.

Examples of candidate operations for blacklisting include the Python and JavaScript eval functions, since they allow arbitrary code in a string to be executed. Other examples of candidate operations for blacklisting are the System.load method, the System.loadLibrary method and the native keyword in Java, since they allow access to native code execution using the Java Native Interface (JNI).

Candidate operations for blacklisting may be inferred based on items present in a blacklist or whitelist and the relationships they may have with other operations. For example, an implementation of the dictionary 420 could decide that any function that references a blacklisted type will automatically be blacklisted.

FIG. 5 is a flow diagram which illustrates an exemplary analysis subsystem 502.

The analysis subsystem 502 receives code via an interface. The code may be received 504 via a program function, memory access, a storage device, a database, a network interface or service, intra and inter-process communication mechanisms.

The code is forwarded to the analyzer 506 for analysis. The analyzer 506 uses an analyzer software component 406 as described earlier and illustrated in FIG. 4, to analyze the code and detect use of prohibited operations.

If the analyzer 506 failed to perform the analysis, for example due to errors in the code, (522 “No” branch), then the code is not forwarded to the post-analysis phase 528.

If the analyzer 506 did not detect any prohibited operations, (524 “No” branch), then the analyzed code is forwarded to the post-analysis phase 528.

If the analyzer 506 detected one or more prohibited operations, (524 “Yes” branch), a Security Policy Decision 526 is made, which may include executing a predetermined security action or not forwarding the code for post-analysis processing (526 “Halt” branch).

A Security Policy Decision may elect to forward the code for post-analysis processing (526 “Override” branch). An example Security Policy Decision is illustrated in FIG. 11 and is described in more detail later in the specification.

The post-analysis processing 528 includes any process that runs after the code has been analyzed, including forwarding the analyzed code directly or indirectly to an execution environment 302.

FIG. 6 is a diagram which illustrates an exemplary monitoring subsystem 602 monitoring an execution environment 202.

The monitoring subsystem 602 monitors one or more execution environments 202, and performs a security action 620, which may include terminating an execution environment 202, if the monitoring subsystem 602 detects abnormal or erroneous behavior in the execution environment 202.

The monitoring subsystem 602 may elect to have any or all of the following sub-components: a time watcher 604, a memory watcher 606, a parallelism watcher 608, a runtime/library watcher 610, and an OS/container watcher 612.

The time watcher 604 is an optional sub-component that monitors how long the execution is taking. The time measured may be the real time (also known as wall-clock time) or it may be the CPU time. An embodiment may measure the cumulative time used up by all parallel tasks (e.g. threads and processes) within the execution environment 202. An embodiment may perform a security action 620, if execution exceeds a time limit threshold.

The memory watcher 606 is an optional sub-component that monitors the memory consumption of an execution environment 202. An embodiment may implement this sub-component by polling operating system APIs that provide process memory usage information such as reading /proc/[pid]/statm in Linux. An embodiment may implement this sub-component by registering for notifications or polling APIs provided by the runtime system, for example using the MemoryMXBean interface and the ManagementFactory class in Java. Embodiments that have the execution components 222 of execution environments 202 running in process partitions, such as .NET AppDomains or Java Protection Domains, may implement this sub-component by registering for notifications or polling APIs that interact with or query process partitions, such as AppDomain.MonitoringSurvivedMemorySize or AppDomain.MonitoringTotalAllocatedMemorySize properties in .NET. An embodiment may perform a security action 620, if the memory usage of the execution environment 202 exceeds a memory size threshold.

The parallelism watcher 608 is an optional sub-component that monitors the level of parallelism of an execution environment 202. An embodiment may implement this sub-component by polling operating system APIs that provide information about the number of parallel tasks (such as threads and child-processes) spawned by a process. Examples are reading /proc/[pid]/stat in Linux or using the Win32 Thread32First, Thread32Next and EnumProcesses functions in Windows. An embodiment may implement this sub-component by polling APIs provided by the runtime system, for example polling the Thread.getAllStackTraces method in Java or the Process.Threads property in .NET. An embodiment may perform a security action 620, if the level of parallelism of the execution environment 202 exceeds a threshold value.

The runtime/library watcher 610 is an optional sub-component that monitors metrics provided by the runtime system or libraries in the execution component 222 of the execution environment 202.

The monitored metrics could be indicative of the health of the runtime system, or could provide information about resources accessed by the runtime system.

An embodiment may implement this sub-component by using management tools such as JMX® for Java. An embodiment may implement this sub-component by using instrumentation libraries or mechanisms such as performance counters in .NET. For example, the “Bytes Sent” .NET performance counter can be monitored to detect excessive network activity. An embodiment may perform a security action 620, if the monitored metrics indicate erroneous behavior.

The OS/Container watcher 612 is an optional sub-component that monitors the operating system, virtualization provider, or containerization provider. The operating system may be monitored to detect if the execution environment 202 is causing any instability to the operating system. The operating system may also be monitored to detect and measure resource usage by the execution environment 202.

An embodiment may implement this sub-component by monitoring metrics provided by the operating system and/or by polling operating system APIs. For example, reading /proc/[pid]/io or /proc/stat in Linux.

An embodiment may perform a security action 620, if the monitored metrics or API calls indicate erroneous behavior.

The monitoring subsystem 602 may monitor for cases that go beyond the responsibilities of its sub-components, such as detecting an unexpected termination of an execution environment 202.

In some embodiments, the monitoring subsystem 602 or its components may be partly or fully responsible for initializing the execution environment 202, so as to easily identify the execution environment's operating system process and to be able to detect erroneous behavior as soon as possible.

Detection of erroneous behavior may be an indication that the permitted operation that led to the erroneous behavior should be prohibited.

A security action 620 is performed when the monitoring subsystem 602 detects erroneous behavior in the execution environment 202. The threshold for triggering the security action may be based on a single factor, such as the time spent during execution or it could be based on a combination of factors such as the time spent and the amount of memory consumed during execution.

Examples of security actions 620 include, but are not limited to, terminating the execution environment 202, allowing the execution environment 202 to continue processing, or alerting a user or agent to make a decision.

The security action 620 may be selected from a predetermined security policy such as the security policy for the host environment or network environment, or corporate or group security policy.

If the security action 620 for an embodiment includes terminating the execution environment 202, the embodiment should ensure that all parallel tasks, such as threads and processes, spawned by the execution environment 202 are also terminated.

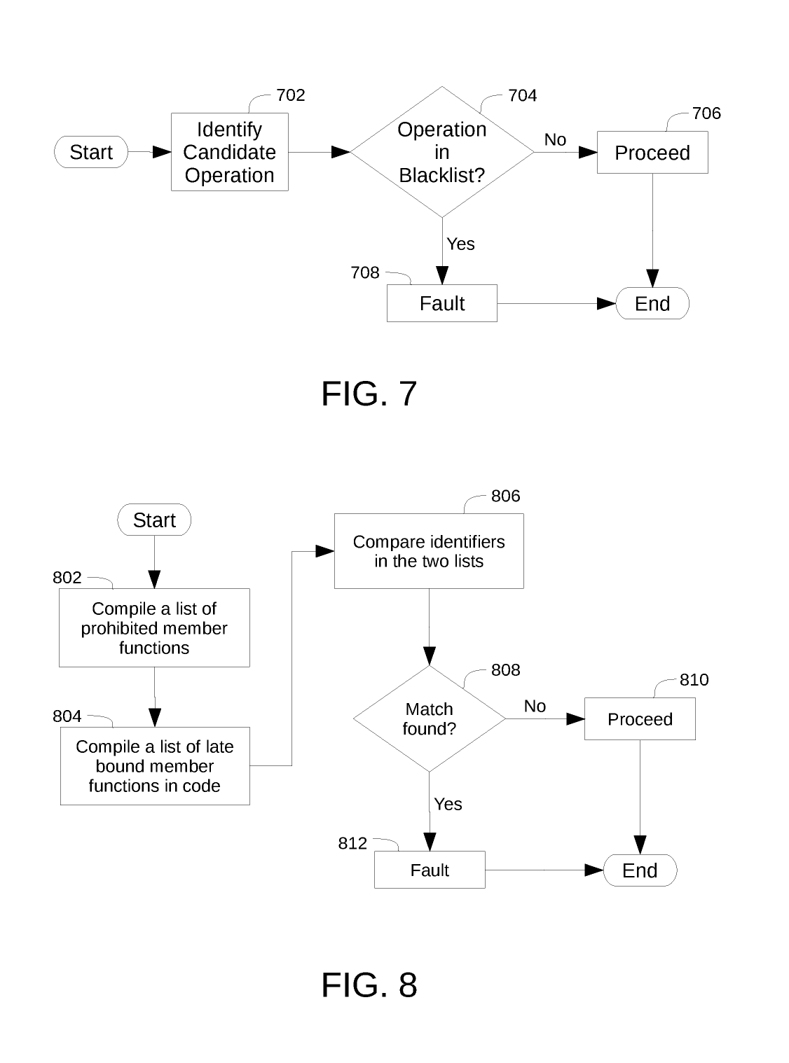

FIG. 7 is a flow diagram which illustrates an example implementation of using a list of constructs to check for prohibited operations as may be found in the compilation/transformation/processing step 308 of the execution environment 302, in the code checker 228 of the execution component 222, or in the analyzer step 506 of the analysis subsystem 502. In this example implementation, the list of constructs is a blacklist containing constructs associated with a set of prohibited operations. Operations can be looked up in the blacklist by searching for an associated construct.

Operations that may be potentially prohibited are identified 702 in the code and are looked up in the blacklist 704. If the operation was not found in the blacklist (704 “No” branch), then the containing subsystem continues processing 706. If the operation was found in the blacklist (704 “Yes” branch), then the containing subsystem may halt processing 708. The lookup 704 may be performed against a whitelist instead of a blacklist, in which case operations found in the whitelist are permitted. The lookup 704 may also be performed against a mix of blacklists and whitelists. For instance, an implementation may have a whitelist containing a list of types that are permitted in code, and also have a blacklist of certain functions belonging to those permitted types that are prohibited in code.

FIG. 8 is a flow diagram which illustrates an example implementation of using heuristics to check for the possibility of the presence of prohibited operations in code, as may be found in the compilation/transformation/processing step 308 of the execution environment 302, in the code checker 228 of the execution component 222, or in the analyzer step 506 of the analysis subsystem 502.

A list of all referenceable prohibited member functions (such as ‘FileInfo.Delete’) is compiled 802. A list of all late bound member functions found in the code (such as the ‘Delete’ in ‘dynamic x; x.Delete( )’) is compiled 804. The names of identifiers in the two lists are compared 806. If there is no match found (808 “No” branch), then the containing subsystem continues processing 810. If one or more matches were found (808 “Yes” branch), then the containing subsystem may halt processing 812, because there is a chance that prohibited operations might be in the code. For example, x.Delete( ) may evaluate to FileInfo.Delete( ) at run time.

FIG. 9 is a flow diagram which illustrates an example implementation of rewriting code to a safer form, as may be found in the compilation/transformation/processing step 308 of the execution environment 302, in the code checker 228 of the execution component 222, or in the analyzer step 506 of the analysis subsystem 502.

The code is analyzed for references to the HttpClient type 902. If references to the HttpClient type is detected (904 “Yes” branch), the references to the HttpClient type are replaced with references to a custom QueuedHttpClient type 906.

In this example implementation, the QueuedHttpClient class has the same contract and is in the same inheritance chain as the standard HttpClient class, and so can serve as a transparent drop-in replacement for the HttpClient class. The custom QueuedHttpClient class, however works differently than the regular HttpClient class. It queues all HTTP requests made from all instances of the class, and processes them one by one, which limits bandwidth usage and avoids port exhaustion in a high load multi-user environment. The custom QueuedHttpClient class may also perform additional tasks that the regular HttpClient class does not, such as logging HTTP requests.

One approach to replacing types, functions, and operations with safer implementations is to perform execution 222 against a version, custom build or configuration of the runtime system 226 or linked libraries 224 where the types, functions, and operations to be substituted have been modified to a safer, more secure or more stable implementation. For instance, the implementation of the default HttpClient class could be replaced with the implementation of the custom QueuedHttpClient class.

An embodiment can achieve finer grained network access control by blocking access to other forms of network communication such as prohibiting access to the Socket class, while permitting access to the HttpClient class which may have a custom implementation.

FIG. 10 is a flow diagram which illustrates an example implementation of compiling code to a lower level representation and analyzing the lower level representation for prohibited operations, as may be found in the compilation/transformation/processing step 308 of the execution environment 302, in the code checker 228 of the execution component 222, or in the analyzer step 506 of the analysis subsystem 502.

In this example, code in a high level language is compiled to LLVM IR 1002. The LLVM IR output is analyzed for prohibited operations 1004 using a blacklist that is specific to the source language 1006, since types, functions and operations in one source language and runtime system will differ from those in a different language and runtime system.

This implementation is thus able to support the plethora of languages that can compile to LLVM IR, without needing a special analyzer for each one. A different implementation may target compilation to .NET CIL or Java bytecode instead, or in addition to LLVM IR, and so is able to support languages that target the .NET or JVM runtime systems.

FIG. 11 is a flow diagram which illustrates an example implementation of a Security Policy Decision, as may be found in the Security Policy Decision step 314 of an execution environment 302, or in the Security Policy Decision step 526 of an analysis subsystem 502. Elements of this example implementation may also be applicable to the Security Action 620 performed by a monitoring subsystem 602.

In this example implementation, If a security policy is not available (1102 “No” branch), as defined in the system, host environment, network environment or corporate or group policy, a “Halt” decision is made, which halts processing of the containing subsystem. If the policy or containing subsystem is set up to skip the security action (1104 “Yes” branch), then processing is transferred to the Override Policy step 1108. If the policy or containing subsystem is not set up to skip the security action (1104 “No” branch), then the security action 1106 is performed. Examples of security actions 1106 include logging, executing a task, or alerting a user or agent. If the policy or containing subsystem is set up to override policy (1108 “Yes” branch), then an “Override” decision is made, which instructs the containing subsystem to continue processing. If the policy or containing subsystem is set up to not override policy (1108 “No” branch), then a “Halt” decision is made, which halts the containing subsystem.

The implementation of a Security Policy Decision may be as simple as a function that always halts the containing subsystem or as complex as one that performs a lookup against a group policy system to determine what actions to take.

FIG. 12 is a flow diagram which illustrates an example implementation of a custom memory allocator, as may be found in the memory limiter 230 of an execution component 222.

The allocation request is received 1202, by the runtime system, runtime host, or memory allocation library. If granting the request will cause a predetermined threshold to be crossed 1204, then the request is denied (1204 “Yes” branch). If granting the request will not cause a predetermined threshold to be crossed 1204, then the request is granted (1204 “No” branch).

A simple implementation may just tally the size of all allocation requests granted, and deny requests once a threshold is reached.

A more sophisticated implementation may calculate how much memory is actually in use by the execution component 222, and factor that, in making the decision.

FIG. 13 is a high level diagram of an exemplary computer system 1302 consistent with systems and methods in the present disclosure. The computer 1302 includes a bus 1304 or other communication mechanism for communicating information, and a processor 1306 coupled with the bus 1304 for processing the information. The computer 1302 also includes a main memory 1308, such as random access memory (RAM) or other dynamic storage device, coupled to the bus 1304 for storing information and instructions to be executed by the processor 1306. In addition, main memory 1308 may be used for storing temporary variables or other intermediate information during execution of instructions to be executed by the processor 1306. Main memory 1308 includes a program 1350 for implementing secure code execution consistent with methods and systems in the present disclosure. The program may include computer-executable instructions that implement elements found in an execution environment 302, in an analysis subsystem 502, or in a monitoring subsystem 602. Computer 1302 further includes a read only memory (ROM) 1310 or other static storage device coupled to the bus 1304 for storing static information and instructions for processor 1306. A storage device 1312, such as a magnetic disk or optical disk, is provided and coupled to bus 1304, for storing information and instructions. The computer 1302 may implement an execution environment 302, an analysis subsystem 502 or a monitoring subsystem 602, as described earlier.

In one embodiment, the processor 1306 executes one or more sequences of one or more instructions contained in main memory 1308. Such instructions may be read into main memory 1308 from another computer readable medium, such as a storage device 1312. Execution of the sequences of instructions in main memory 1308 causes processor 1306 to perform the process steps described herein. One or more processors in a multi-processing arrangement may also be employed to execute the sequences of instructions contained in main memory 1308. In alternative embodiments, hard-wired circuitry may be used in place of or in combination with software instructions. Thus, embodiments are not limited to any specific combination of hardware circuitry and software.

Although described relative to main memory 1308 and the storage device 1312, instructions and other aspects of methods and systems consistent with the present disclosure may reside on another computer-readable medium, such as a floppy disk, a flexible disk, hard disk, flash drive, magnetic tape, a CD-ROM, magnetic, optical or physical medium, a RAM, a PROM, an EPROM, a FLASH-EPROM, any other memory chip or cartridge, or any other medium from which a computer can read, either now known or later discovered.

The computer 1302 also includes a communication interface 1320 coupled to the bus 1304. Communication interface 1320 provides a two-way data communication coupling to a network link 1322 that is connected to a network 1324, such as the Internet or other computer network. Wireless links may also be implemented. In any such implementation, communication interface 1320 sends and receives signals that carry digital data streams representing various types of information.

In one implementation, computer 1302 may operate as a server on a computer network 1324 such as the Internet. Computer 1302 may also represent other computers on the Internet, such as mobile devices or users' computers having web browsers. The users' computers may have similar components as computer 1302.

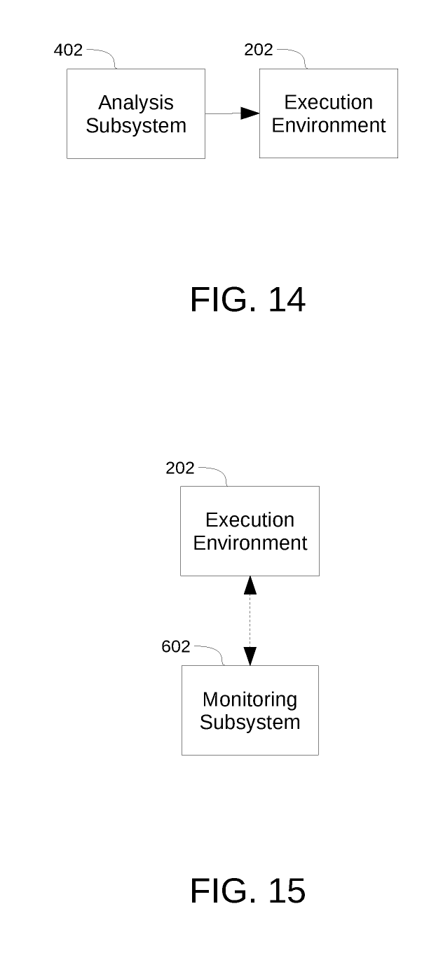

FIG. 14 is a high level diagram of an embodiment that comprises an analysis subsystem 402 and an execution environment 202. The monitoring subsystem 602 is not present in this embodiment. An embodiment may be set up in this arrangement if it is determined that the execution environment 202, coupled with the pre-identified set of permitted operations, has sufficient protection against erroneous behavior.

FIG. 15 is a high level diagram of an embodiment that comprises an execution environment 202 and a monitoring subsystem 602. The analysis subsystem 402 is not present in this embodiment. An embodiment may be set up in this arrangement if it is determined that the execution environment 202, coupled with the monitoring subsystem 602, sufficiently prevents execution of prohibited operations or the adverse effects of prohibited operations if executed.

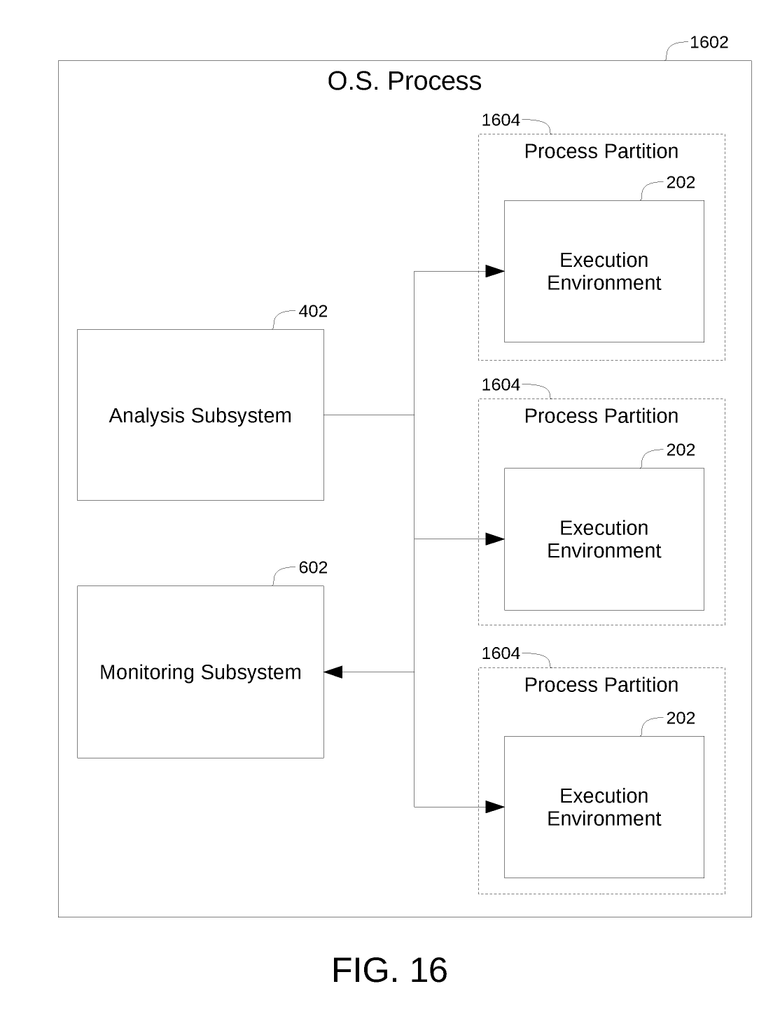

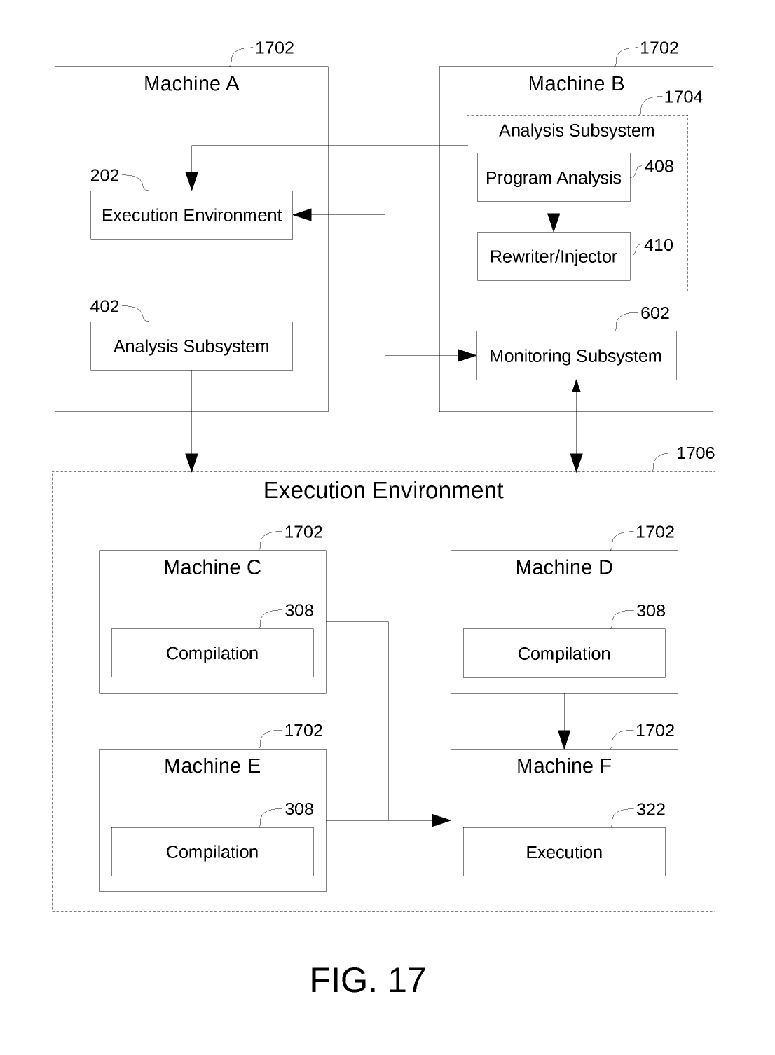

FIG. 16 is a high level diagram of an embodiment that is set up to have an analysis subsystem 402, a monitoring subsystem 602, and multiple execution environments 202, all functioning in a single operating system process 1602. Each execution environment 202 functions within a process partition 1604, such as a .NET AppDomain or a Java Protection Domain, to isolate the execution component 222 of the execution environment 202 from elements in other execution environments 202. If the runtime system does not have a process partition feature, each process 1602 may contain one execution environment 202. Multiple processes 1602 may then be spawned to create multiple isolated execution environments 202. Execution environments 202 may not be set up to function within process partitions 1604 if interaction between execution environments 202 is desired. Since the embodiment functions in a single operating system process, it is easily packaged as a portable and easy to deploy solution.

FIG. 17 is a high level diagram of an embodiment that spans multiple machines 1702 and operating system processes. The machines 1702 may be physical or virtual machines.

In this embodiment, some components are set up as standalone operating system processes, while elements of some components are set up as standalone operating system processes. Processes in the same machine or in different machines communicate with each other using inter-process or network communication mechanisms.

Machine A runs an execution environment 202 as a single operating system process, and an analysis subsystem 402 as a single operating system process.

Machine B runs the program analysis sub-component 408 of the analyzer component 406 of an analysis subsystem 402 as a single separate operating system process, and the rewriter/injector sub-component 410 of the analyzer component 406 of an analysis subsystem 402 as a single separate operating system process. Together, the program analysis 408 and the rewriter/injector 410 processes on Machine B form a logical analysis subsystem 1704. Machine B also runs a monitoring subsystem 602 as a single operating system process.

Machines C, D, E, and F each run a step of the execution environment 302 as a single separate operating system process. Machines C, D and E perform a distributed compilation 308 of the code, while Machine F performs the execution 322 of the compiled output. Together Machines C, D, E, and F form a logical execution environment 1706.

The analysis subsystem 1704 of Machine B analyzes the code and transfers the analyzed code to the execution environment 202 of Machine A for processing.

The analysis subsystem 402 of Machine A analyzes the code and transfers the analyzed code to the compilation 308 processes of Machines C, D and E.

The monitoring subsystem 602 of Machine B monitors the execution environment 202 process in Machine A and the logical execution environment 1706 comprising Machines C, D, E, and F.

In this embodiment, various components and elements function as loosely coupled, self-contained units, thus making the embodiment suitable for scalable enterprise, software as a service (SaaS), cloud and service oriented solutions.

Accordingly, it can be seen that the described systems and methods can be used to verify programs and to secure code execution.

The present disclosure is not tied to operating system specific features or to sandboxing features provided by an operating system, virtualization or containerization provider.

Systems and methods in accordance with the present disclosure offer flexibility in the scope of operation. They may operate as single process solutions and they may operate as a multi-process, multi-machine distributed solutions.

Systems and methods in accordance with the present disclosure offer flexibility in the level of scrutiny and granularity during verification.

Systems and methods in accordance with the present disclosure can be used in securing the delivery of mobile applications, either by verifying the applications at the point of submission to an app store, or during installation and execution on the device.

Technologies that deliver native application experiences to devices, without requiring an installation, such as Android Instant Apps, can use systems and methods in accordance with the present disclosure to provide secure decentralized delivery of software. In this delivery model, there is no central app store or gatekeeper for application delivery. Software publishers can host their software anywhere they choose, similar to the decentralized manner in which the World Wide Web operates. Verification and monitoring is performed at the point of reception and execution of the delivered software on the device, to ensure safety. There is also no need to perform verification against a central catalog of known malware.

The present disclosure is applicable to a wide variety of programming languages, code formats, runtime systems, platforms, operating systems, and hardware.

In the description above, numerous specific embodiments and examples have been set forth in order to provide a thorough understanding of the present disclosure.

These embodiments and examples are provided solely to add context and aid in the understanding of the present disclosure. Although these embodiments are described in sufficient detail, to enable one skilled in the art to practice the present disclosure, these examples, illustrations and contexts are not limiting, and other embodiments may be used and changes may be made without departing from the spirit and scope of the present disclosure.

Reference in the specification to “one embodiment” or to “an embodiment” means that a particular feature, structure or characteristic described in connection with the embodiments is included in at least one embodiment of the present disclosure, and multiple references to “one embodiment” or “an embodiment” should not be understood as necessarily referring to the same embodiment.

In some instances, well known concepts have not been described in detail in order to avoid unnecessarily obscuring the present disclosure.

All trademarks in the specification are mentioned only to aid in the understanding of the present disclosure. Java and JMX are registered trademarks of Oracle America, Inc. AppleScript and Swift are registered trademarks of Apple Inc. Scratch is a registered trademark of the Massachusetts Institute of Technology. LabVIEW is a registered trademark of National Instruments Corporation. MATLAB is a registered trademark of The MathWorks, Inc. Coq is a registered trademark of INRIA. Linux is a registered trademark of Linus Torvalds. Windows and Win32 are registered trademarks of Microsoft Corporation. Kotlin and Intend are registered trademarks of JetBrains s.r.o. LLVM is a registered trademark of the LLVM Foundation. Android and Dalvik are registered trademarks of Google Inc. GNU is a registered trademark of the Free Software Foundation. All other marks mentioned may be trademarks or registered trademarks of their respective owners.

What is claimed is:

1. A computer-implemented method, comprising:
a. providing an execution environment that receives code, and executes the code;
b. identifying a set of prohibited operations, including access to types, field access, function calls, method calls, language keywords, syntax, instructions, and operations;
c. analyzing code, with an analysis subsystem, to detect use of at least one of said prohibited operations; and
d. communicating code analyzed by said analysis subsystem, to the execution environment, if the code is determined by the analysis subsystem to be satisfactory for execution.

2. The method according to claim 1, further comprising:
a. specifying a security action to be performed when said execution environment exhibits erroneous behavior that puts at risk the operational safety of a system selected from a group consisting of said execution environment, its network environment and its host environment; and
b. monitoring at least one instance of an execution environment for erroneous behavior, and performing said security action, if erroneous behavior is detected.

3. The method according to claim 1, wherein said execution environment employs conventional security and sandboxing mechanisms provided by a software system selected from a group consisting of a compiler, referenced libraries, runtime system, software container, operating system and virtualization provider, to improve safety and security during code execution.

4. The method according to claim 1, further comprising: providing a means to isolate a memory address space accessible to an execution environment from memory address spaces accessible to other instances of execution environments.

5. The method according to claim 1, wherein said execution environment provides a means to prevent a call stack overflow encountered during code execution, from halting a host operating system process.

6. The method according to claim 1, wherein said execution environment performs code execution against an installation selected from a group consisting of a version of a runtime system, a version of referenced libraries, a custom build of a runtime system, a custom build of referenced libraries, configuration of a runtime system, and configuration of referenced libraries, where at least one of said prohibited operations is modified to be unworkable, including being removed, being hidden and being modified with restricted capabilities.

7. The method according to claim 1, further comprising: equipping said execution environment with an installation selected from a group consisting of a version of a runtime system, a version of referenced libraries, a custom build of a runtime system, a custom build of referenced libraries, configuration of a runtime system, and configuration of referenced libraries, that checks for at least one of said prohibited operations, in real time, during code execution.

8. The method according to claim 1, wherein said execution environment provides a means to limit the amount of consumable memory during code execution.

9. The method according to claim 1, wherein said execution environment provides a means to limit the level of parallelism during code execution.

10. The method according to claim 1, further comprising: equipping said execution environment with an installation selected from a group consisting of a version of a runtime system, a version of referenced libraries, a custom build of a runtime system, a custom build of referenced libraries, configuration of a runtime system, and configuration of referenced libraries, where an implementation of at least one code construct including types, functions, methods, instructions and operations, is modified to improve operational safety during code execution.

11. The method according to claim 1, further comprising: equipping said execution environment with an installation selected from a group consisting of a version of a runtime system, a version of referenced libraries, a custom build of a runtime system, a custom build of referenced libraries, configuration of a runtime system, and configuration of referenced libraries, where at least one code construct including types, functions, methods, instructions and operations, that accesses a restricted system resource, is modified to limit the rate of concurrent access to the system resource.

12. The method according to claim 1, wherein the said set of prohibited operations is identified as an inverse or complement of a pre-identified set of permitted operations.

13. The method according to claim 1, wherein said execution environment performs processing, including compilations and transformations, on the code, after the code is received but before the code is executed.

14. The method according to claim 13, wherein said execution environment provides a means to detect at least one of said prohibited operations while performing said processing.

15. The method according to claim 14, wherein detection of a given operation as a prohibited operation, by said execution environment, is based on the presence of a construct associated with the given operation, in a predetermined list of constructs including types, functions, methods, keywords, instructions and operations.

16. The method according to claim 14, further comprising: performing an action, including halting the execution environment, according to a predetermined security policy on detection of at least one of said prohibited operations.

17. The method according to claim 14, further comprising: rewriting a detected prohibited operation into a safer form selected from a group consisting of unworkable forms, forms with limited capabilities, and safe alternative operations.

18. The method according to claim 13, wherein said execution environment injects new code or modifies provided code, during said processing, to improve operational safety during code execution.

19. The method according to claim 1, wherein detection of a given operation as a prohibited operation, by said analysis subsystem, is based on the presence of a construct associated with the given operation, in a predetermined list of constructs including types, functions, methods, keywords, instructions and operations.

20. The method according to claim 19, further comprising: inferring other constructs to be checked during detection, based on associations or references between available constructs and constructs in said predetermined list.

21. The method according to claim 1, wherein said analysis subsystem uses heuristics to inspect code and determine the possibility of the use of at least one of said prohibited operations.

22. The method according to claim 1, wherein said analysis subsystem detects operations that may potentially destabilize the runtime system.

23. The method according to claim 1, further comprising: injecting new code or modifying provided code by said analysis subsystem, to improve operational safety during code execution by said execution environment.

24. The method according to claim 1, wherein said analysis subsystem detects a prohibited operation and rewrites the operation into a safe alternative operation.

25. The method according to claim 1, wherein said analysis subsystem detects access to a restricted system resource and rewrites the code to use a different operation that accesses the system resource in a safe manner.

26. The method according to claim 1, wherein said analysis subsystem refers to a predetermined security policy to select an appropriate action to perform when code is determined to be unsafe.

27. A computer-implemented method, comprising:
a. providing an execution environment that receives code, and executes the code;
b. specifying a security action to be performed, when said execution environment exhibits erroneous behavior that puts at risk the operational safety of a system selected from a group consisting of said execution environment, its network environment and its host environment; and
c. monitoring at least one instance of an execution environment for erroneous behavior, and performing said security action, if erroneous behavior is detected.

28. The method according to claim 27, further comprising:
a. identifying a set of prohibited operations, including access to types, field access, function calls, method calls, language keywords, syntax, instructions, and operations;
b. analyzing code, with an analysis subsystem, to detect use of at least one of said prohibited operations; and
c. communicating code analyzed by said analysis subsystem, to the execution environment, if the code is determined by the analysis subsystem to be satisfactory for execution.

29. The method according to claim 27, wherein said security action includes halting the execution environment.

30. The method according to claim 27, wherein said security action is derived from a predetermined security policy.

31. The method according to claim 27, wherein said monitoring involves monitoring the amount of time the execution environment spent executing code and performing said security action, if a time limit related threshold is crossed.

32. The method according to claim 27, wherein said monitoring involves monitoring memory consumption by the execution environment and performing said security action, if a memory size related threshold is crossed.

33. The method according to claim 27, wherein said monitoring involves monitoring the level of parallelism of the execution environment and performing said security action, if a parallelism level related threshold is exceeded.

34. The method according to claim 27, further comprising: monitoring at least one metric provided by a software system selected from a group consisting of a compiler, referenced libraries, runtime system, software container, operating system and virtualization provider, and performing said security action, if a metric related threshold is crossed.

35. The method according to claim 27, further comprising: monitoring operating system or virtualization provider resources, including network access, disk access and system calls, and performing said security action, if a resource related threshold is crossed.

36. The method according to claim 27, wherein said execution environment employs conventional security and sandboxing mechanisms provided by a software system selected from a group consisting of a compiler, referenced libraries, runtime system, software container, operating system and virtualization provider, to improve safety and security during code execution.

37. The method according to claim 27, further comprising: providing a means to isolate a memory address space accessible to an execution environment from memory address spaces accessible to other instances of execution environments.

38. The method according to claim 27, wherein said execution environment provides a means to prevent a call stack overflow encountered during code execution, from halting a host operating system process.

39. The method according to claim 27, further comprising:
a. identifying a set of prohibited operations, including access to types, field access, function calls, method calls, language keywords, syntax, instructions, and operations; and
b. equipping said execution environment with an installation selected from a group consisting of a version of a runtime system, a version of referenced libraries, a custom build of a runtime system, a custom build of referenced libraries, configuration of a runtime system, and configuration of referenced libraries, where at least one of said prohibited operations is modified to be unworkable, including being removed, being hidden and being modified with restricted capabilities.

40. The method according to claim 27, further comprising:
a. identifying a set of prohibited operations, including access to types, field access, function calls, method calls, language keywords, syntax, instructions, and operations; and
b. equipping said execution environment with an installation selected from a group consisting of a version of a runtime system, a version of referenced libraries, a custom build of a runtime system, a custom build of referenced libraries, configuration of a runtime system, and configuration of referenced libraries, that checks for at least one of said prohibited operations, in real time, during code execution.

41. The method according to claim 27, wherein said execution environment provides a means to limit the amount of consumable memory during code execution.

42. The method according to claim 27, wherein said execution environment provides a means to limit the level of parallelism during code execution.

43. The method according to claim 27, further comprising: equipping said execution environment with an installation selected from a group consisting of a version of a runtime system, a version of referenced libraries, a custom build of a runtime system, a custom build of referenced libraries, configuration of a runtime system, and configuration of referenced libraries, where an implementation of at least one code construct including types, functions, methods, instructions and operations, is modified to improve operational safety during code execution.

44. The method according to claim 27, further comprising: equipping said execution environment with an installation selected from a group consisting of a version of a runtime system, a version of referenced libraries, a custom build of a runtime system, a custom build of referenced libraries, configuration of a runtime system, and configuration of referenced libraries, where at least one code construct including types, functions, methods, instructions and operations, that accesses a restricted system resource, is modified to limit the rate of concurrent access to the system resource.

45. The method according to claim 27, wherein said execution environment performs processing, including compilations and transformations, on the code, after the code is received but before the code is executed.

46. The method according to claim 45, further comprising:
a. identifying a set of prohibited operations, including access to types, field access, function calls, method calls, language keywords, syntax, instructions, and operations; and
b. providing a means for said execution environment to detect at least one of said prohibited operations while performing said processing.

47. The method according to claim 46, wherein the said set of prohibited operations is identified as an inverse or complement of a pre-identified set of permitted operations.

48. The method according to claim 46, wherein detection of a given operation as a prohibited operation, by said execution environment, is based on the presence of a construct associated with the given operation, in a predetermined list of constructs including types, functions, methods, keywords, instructions and operations.

49. The method according to claim 46, further comprising: performing an action, including halting the execution environment, according to a predetermined security policy on detection of at least one of said prohibited operations.

50. The method according to claim 46, further comprising: rewriting a detected prohibited operation into a safer form selected from a group consisting of unworkable forms, forms with limited capabilities, and safe alternative operations.

51. The method according to claim 45, wherein said execution environment injects new code or modifies provided code, during said processing, to improve operational safety during code execution.

52. A computer-implemented method, comprising:
a. providing an execution environment that receives code, and executes the code;
b. identifying a set of prohibited operations, including access to types, field access, function calls, method calls, language keywords, syntax, instructions, and operations; and
c. providing a means for said execution environment to analyze code and detect use of at least one of said prohibited operations.

53. The method according to claim 52, wherein said execution environment employs conventional security and sandboxing mechanisms provided by a software system selected from a group consisting of a compiler, referenced libraries, runtime system, software container, operating system and virtualization provider, to improve safety and security during code execution.

54. The method according to claim 52, further comprising: providing a means to isolate a memory address space accessible to an execution environment from memory address spaces accessible to other instances of execution environments.

55. The method according to claim 52, wherein said execution environment provides a means to prevent a call stack overflow encountered during code execution, from halting a host operating system process.

56. The method according to claim 52, wherein said execution environment performs code execution against an installation selected from a group consisting of a version of a runtime system, a version of referenced libraries, a custom build of a runtime system, a custom build of referenced libraries, configuration of a runtime system, and configuration of referenced libraries, where at least one of said prohibited operations is modified to be unworkable, including being removed, being hidden and being modified with restricted capabilities.

57. The method according to claim 52, further comprising: equipping said execution environment with an installation selected from a group consisting of a version of a runtime system, a version of referenced libraries, a custom build of a runtime system, a custom build of referenced libraries, configuration of a runtime system, and configuration of referenced libraries, that checks for at least one of said prohibited operations, in real time, during code execution.

58. The method according to claim 52, wherein said execution environment provides a means to limit the amount of consumable memory during code execution.

59. The method according to claim 52, wherein said execution environment provides a means to limit the level of parallelism during code execution.

60. The method according to claim 52, further comprising: equipping said execution environment with an installation selected from a group consisting of a version of a runtime system, a version of referenced libraries, a custom build of a runtime system, a custom build of referenced libraries, configuration of a runtime system, and configuration of referenced libraries, where an implementation of at least one code construct including types, functions, methods, instructions and operations, is modified to improve operational safety during code execution.

61. The method according to claim 52, further comprising: equipping said execution environment with an installation selected from a group consisting of a version of a runtime system, a version of referenced libraries, a custom build of a runtime system, a custom build of referenced libraries, configuration of a runtime system, and configuration of referenced libraries, where at least one code construct including types, functions, methods, instructions and operations, that accesses a restricted system resource, is modified to limit the rate of concurrent access to the system resource.

62. The method according to claim 52, wherein the said set of prohibited operations is identified as an inverse or complement of a pre-identified set of permitted operations.

63. The method according to claim 52, wherein detection of a given operation as a prohibited operation, by said execution environment, is based on the presence of a construct associated with the given operation, in a predetermined list of constructs including types, functions, methods, keywords, instructions and operations.

64. The method according to claim 52, further comprising: performing an action, including halting the execution environment, according to a predetermined security policy on detection of at least one of said prohibited operations.

65. The method according to claim 52, further comprising: rewriting a detected prohibited operation into a safer form selected from a group consisting of unworkable forms, forms with limited capabilities, and safe alternative operations.

66. The method according to claim 52, wherein said execution environment performs processing, including compilations and transformations, on the code, after the code is received but before the code is executed.

67. The method according to claim 66, wherein said execution environment injects new code or modifies provided code, during said processing, to improve operational safety during code execution.

68. A system, comprising:
a. an execution environment configured to receive code, and to execute the code;
b. an identification mechanism configured to identify a set of prohibited operations, including access to types, field access, function calls, method calls, language keywords, syntax, instructions, and operations;
c. an analysis subsystem configured to analyze code and to use said identification mechanism, to detect use of at least one of said prohibited operations; and
d. a communication mechanism configured to communicate code analyzed by said analysis subsystem, to the execution environment.

69. The system according to claim 68, further comprising:
a. a security action mechanism, configured to perform a security action when said execution environment exhibits erroneous behavior that puts at risk the operational safety of a system selected from a group consisting of said execution environment, its network environment and its host environment; and
b. a monitoring mechanism configured to monitor at least one instance of an execution environment for erroneous behavior, and to cause said security action mechanism to perform a security action, if erroneous behavior is detected.

70. The system according to claim 68, wherein said execution environment is configured to employ conventional security and sandboxing mechanisms provided by a software system selected from a group consisting of a compiler, referenced libraries, runtime system, software container, operating system and virtualization provider.

71. The system according to claim 68, further comprising: a means to isolate a memory address space accessible to an execution environment from memory address spaces accessible to other instances of execution environments.

72. The system according to claim 68, wherein said execution environment is configured to prevent a call stack overflow encountered during code execution, from halting a host operating system process.

73. The system according to claim 68, wherein said execution environment is configured to perform code execution against an installation selected from a group consisting of a version of a runtime system, a version of referenced libraries, a custom build of a runtime system, a custom build of referenced libraries, configuration of a runtime system, and configuration of referenced libraries, where at least one of said prohibited operations is modified to be unworkable, including being removed, being hidden and being modified with restricted capabilities.

74. The system according to claim 68, wherein said execution environment is equipped with an installation selected from a group consisting of a version of a runtime system, a version of referenced libraries, a custom build of a runtime system, a custom build of referenced libraries, configuration of a runtime system, and configuration of referenced libraries, that checks for at least one of said prohibited operations, in real time, during code execution.

75. The system according to claim 68, wherein said execution environment is configured with a means to limit the amount of consumable memory during code execution.

76. The system according to claim 68, wherein said execution environment is configured with a means to limit the level of parallelism during code execution.

77. The system according to claim 68, wherein said execution environment is equipped with an installation selected from a group consisting of a version of a runtime system, a version of referenced libraries, a custom build of a runtime system, a custom build of referenced libraries, configuration of a runtime system, and configuration of referenced libraries, where an implementation of at least one code construct including types, functions, methods, instructions and operations, is modified to improve operational safety during code execution.

78. The system according to claim 68, wherein said execution environment is equipped with an installation selected from a group consisting of a version of a runtime system, a version of referenced libraries, a custom build of a runtime system, a custom build of referenced libraries, configuration of a runtime system, and configuration of referenced libraries, where at least one code construct including types, functions, methods, instructions and operations, that accesses a restricted system resource, is modified to limit the rate of concurrent access to the system resource.

79. The system according to claim 68, wherein the identification mechanism is configured to identify the said set of prohibited operations as an inverse or complement of a pre-identified set of permitted operations.

80. The system according to claim 68, wherein said execution environment is configured to perform processing, including compilations and transformations, on the code, after the code is received but before the code is executed.

81. The system according to claim 80, wherein said execution environment, coupled with said identification mechanism, is configured with a means to detect at least one of said prohibited operations while performing said processing.

82. The system according to claim 81, further comprising: a mechanism to perform an action, including halting the execution environment, according to a predetermined security policy on detection of at least one of said prohibited operations.

83. The system according to claim 81, further comprising: a mechanism to rewrite a detected prohibited operation into a safer form selected from a group consisting of unworkable forms, forms with limited capabilities, and safe alternative operations.

84. The system according to claim 80, wherein said execution environment is configured to inject new code or to modify provided code, during said processing.

85. The system according to claim 68, wherein said identification mechanism includes a predetermined list of constructs including types, functions, methods, keywords, instructions and operations.

86. The system according to claim 85, further comprising: a mechanism to infer other constructs, based on associations or references between available constructs and constructs in said predetermined list.

87. The system according to claim 68, wherein said analysis subsystem is configured to use heuristics to inspect code and determine the possibility of the use of at least one of said prohibited operations.

88. The system according to claim 68, wherein said analysis subsystem is configured to detect operations that may potentially destabilize the runtime system.

89. The system according to claim 68, further comprising: a mechanism for said analysis subsystem to inject new code or to modify provided code.

90. The system according to claim 68, wherein said analysis subsystem is configured to detect a prohibited operation and to rewrite the operation into a safe alternative operation.

91. The system according to claim 68, wherein said analysis subsystem is configured to detect access to a restricted system resource and to rewrite the code to use a different operation that accesses the system resource in a safe manner.

92. The system according to claim 68, wherein said analysis subsystem includes a mechanism that refers to a predetermined security policy, to select an appropriate action to perform when code is determined to be unsafe.

93. A system, comprising:
a. an execution environment configured to receive code, and to execute the code;
b. a security action mechanism configured to perform a security action when said execution environment exhibits erroneous behavior that puts at risk the operational safety of a system selected from a group consisting of said execution environment, its network environment and its host environment; and
c. a monitoring mechanism configured to monitor at least one instance of an execution environment for erroneous behavior, and to cause said security action mechanism to perform a security action, if erroneous behavior is detected.

94. The system according to claim 93, further comprising:
a. an identification mechanism configured to identify a set of prohibited operations, including access to types, field access, function calls, method calls, language keywords, syntax, instructions, and operations;
b. an analysis subsystem configured to analyze code and to use said identification mechanism, to detect use of at least one of said prohibited operations; and
c. a communication mechanism configured to communicate code analyzed by said analysis subsystem, to the execution environment.

95. The system according to claim 93, wherein said security action includes halting the execution environment.

96. The system according to claim 93, wherein said security action is derived from a predetermined security policy.

97. The system according to claim 93, wherein said monitoring mechanism is configured to monitor the amount of time the execution environment spent executing code and to perform said security action, if a time limit related threshold is crossed.

98. The system according to claim 93, wherein said monitoring mechanism is configured to monitor memory consumption by the execution environment and to perform said security action, if a memory size related threshold is crossed.

99. The system according to claim 93, wherein said monitoring mechanism is configured to monitor the level of parallelism of the execution environment and to perform said security action, if a parallelism level related threshold is exceeded.

100. The system according to claim 93, further comprising: a mechanism for monitoring at least one metric provided by a software system selected from a group consisting of a compiler, referenced libraries, runtime system, software container, operating system and virtualization provider, and for performing said security action, if a metric related threshold is crossed.

101. The system according to claim 93, further comprising: a mechanism for monitoring operating system or virtualization provider resources, including network access, disk access and system calls, and for performing said security action, if a resource related threshold is crossed.

102. The system according to claim 93, wherein said execution environment is configured to employ conventional security and sandboxing mechanisms provided by a software system selected from a group consisting of a compiler, referenced libraries, runtime system, software container, operating system and virtualization provider.

103. The system according to claim 93, further comprising: a means to isolate a memory address space accessible to an execution environment from memory address spaces accessible to other instances of execution environments.

104. The system according to claim 93, wherein said execution environment is configured to prevent a call stack overflow encountered during code execution, from halting a host operating system process.

105. The system according to claim 93, further comprising an identification mechanism configured to identify a set of prohibited operations, and wherein said execution environment is equipped with an installation selected from a group consisting of a version of a runtime system, a version of referenced libraries, a custom build of a runtime system, a custom build of referenced libraries, configuration of a runtime system, and configuration of referenced libraries, where at least one of said prohibited operations is modified to be unworkable, including being removed, being hidden and being modified with restricted capabilities.

106. The system according to claim 93, further comprising an identification mechanism configured to identify a set of prohibited operations, and wherein said execution environment is equipped with an installation selected from a group consisting of a version of a runtime system, a version of referenced libraries, a custom build of a runtime system, a custom build of referenced libraries, configuration of a runtime system, and configuration of referenced libraries, that checks for at least one of said prohibited operations, in real time, during code execution.

107. The system according to claim 93, wherein said execution environment is configured with a means to limit the amount of consumable memory during code execution.

108. The system according to claim 93, wherein said execution environment is configured with a means to limit the level of parallelism during code execution.

109. The system according to claim 93, wherein said execution environment is equipped with an installation selected from a group consisting of a version of a runtime system, a version of referenced libraries, a custom build of a runtime system, a custom build of referenced libraries, configuration of a runtime system, and configuration of referenced libraries, where an implementation of at least one code construct including types, functions, methods, instructions and operations, is modified to improve operational safety during code execution.

110. The system according to claim 93, wherein said execution environment is equipped with an installation selected from a group consisting of a version of a runtime system, a version of referenced libraries, a custom build of a runtime system, a custom build of referenced libraries, configuration of a runtime system, and configuration of referenced libraries, where at least one code construct including types, functions, methods, instructions and operations, that accesses a restricted system resource, is modified to limit the rate of concurrent access to the system resource.

111. The system according to claim 93, wherein said execution environment is configured to perform processing, including compilations and transformations, on the code, after the code is received but before the code is executed.

112. The system according to claim 111, further comprising an identification mechanism configured to identify a set of prohibited operations, and wherein said execution environment coupled with said identification mechanism, includes a means to detect at least one of said prohibited operations while performing said processing.

113. The system according to claim 112, wherein the identification mechanism is configured to identify the said set of prohibited operations as an inverse or complement of a pre-identified set of permitted operations.

114. The system according to claim 112, wherein said identification mechanism includes a predetermined list of constructs including types, functions, methods, keywords, instructions and operations.

115. The system according to claim 112, further comprising: a mechanism to perform an action, including halting the execution environment, according to a predetermined security policy on detection of at least one of said prohibited operations.

116. The system according to claim 112, further comprising: a mechanism to rewrite a detected prohibited operation into a safer form selected from a group consisting of unworkable forms, forms with limited capabilities, and safe alternative operations.

117. The system according to claim 111, wherein said execution environment is configured to inject new code or to modify provided code, during said processing.

118. A system, comprising:
a. an execution environment configured to receive code, and to execute the code;
b. an identification mechanism configured to identify a set of prohibited operations, including access to types, field access, function calls, method calls, language keywords, syntax, instructions, and operations; and
c. a means for said execution environment coupled with said identification mechanism, to analyze code and detect use of at least one of said prohibited operations.

119. The system according to claim 118, wherein said execution environment is configured to employ conventional security and sandboxing mechanisms provided by a software system selected from a group consisting of a compiler, referenced libraries, runtime system, software container, operating system and virtualization provider.

120. The system according to claim 118, further comprising: a means to isolate a memory address space accessible to an execution environment from memory address spaces accessible to other instances of execution environments.

121. The system according to claim 118, wherein said execution environment is configured to prevent a call stack overflow encountered during code execution, from halting a host operating system process.

122. The system according to claim 118, wherein said execution environment is configured to perform code execution against an installation selected from a group consisting of a version of a runtime system, a version of referenced libraries, a custom build of a runtime system, a custom build of referenced libraries, configuration of a runtime system, and configuration of referenced libraries, where at least one of said prohibited operations is modified to be unworkable, including being removed, being hidden and being modified with restricted capabilities.

123. The system according to claim 118, wherein said execution environment is equipped with an installation selected from a group consisting of a version of a runtime system, a version of referenced libraries, a custom build of a runtime system, a custom build of referenced libraries, configuration of a runtime system, and configuration of referenced libraries, that checks for at least one of said prohibited operations, in real time, during code execution.

124. The system according to claim 118, wherein said execution environment is configured with a means to limit the amount of consumable memory during code execution.

125. The system according to claim 118, wherein said execution environment is configured with a means to limit the level of parallelism during code execution.

126. The system according to claim 118, wherein said execution environment is equipped with an installation selected from a group consisting of a version of a runtime system, a version of referenced libraries, a custom build of a runtime system, a custom build of referenced libraries, configuration of a runtime system, and configuration of referenced libraries, where an implementation of at least one code construct including types, functions, methods, instructions and operations, is modified to improve operational safety during code execution.

127. The system according to claim 118, wherein said execution environment is equipped with an installation selected from a group consisting of a version of a runtime system, a version of referenced libraries, a custom build of a runtime system, a custom build of referenced libraries, configuration of a runtime system, and configuration of referenced libraries, where at least one code construct including types, functions, methods, instructions and operations, that accesses a restricted system resource, is modified to limit the rate of concurrent access to the system resource.

128. The system according to claim 118, wherein the identification mechanism is configured to identify the said set of prohibited operations as an inverse or complement of a pre-identified set of permitted operations.

129. The system according to claim 118, wherein said identification mechanism includes a predetermined list of constructs including types, functions, methods, keywords, instructions and operations.

130. The system according to claim 118, further comprising: a mechanism to perform an action, including halting the execution environment, according to a predetermined security policy on detection of at least one of said prohibited operations.

131. The system according to claim 118, further comprising: a mechanism to rewrite a detected prohibited operation into a safer form selected from a group consisting of unworkable forms, forms with limited capabilities, and safe alternative operations.

132. The system according to claim 118, wherein said execution environment is configured to perform processing, including compilations and transformations, on the code, after the code is received but before the code is executed.

133. The system according to claim 132, wherein said execution environment is configured to inject new code or to modify provided code, during said processing.

134. A non-transitory computer-readable storage medium storing instructions that when executed by one or more computers cause the computers to perform a method comprising:
a. providing an execution environment that receives code, and executes the code;
b. identifying a set of prohibited operations, including access to types, field access, function calls, method calls, language keywords, syntax, instructions, and operations;
c. analyzing code, with an analysis subsystem, to detect use of at least one of said prohibited operations; and
d. communicating code analyzed by said analysis subsystem, to the execution environment, if the code is determined by the analysis subsystem to be satisfactory for execution.

135. The non-transitory computer-readable storage medium according to claim 134, storing instructions further comprising:
a. specifying a security action to be performed when said execution environment exhibits erroneous behavior that puts at risk the operational safety of a system selected from a group consisting of said execution environment, its network environment and its host environment; and
b. monitoring at least one instance of an execution environment for erroneous behavior, and performing said security action, if erroneous behavior is detected.

136. The non-transitory computer-readable storage medium according to claim 134, storing instructions wherein said execution environment employs conventional security and sandboxing mechanisms provided by a software system selected from a group consisting of a compiler, referenced libraries, runtime system, software container, operating system and virtualization provider, to improve safety and security during code execution.

137. The non-transitory computer-readable storage medium according to claim 134, storing instructions further comprising: providing a means to isolate a memory address space accessible to an execution environment from memory address spaces accessible to other instances of execution environments.

138. The non-transitory computer-readable storage medium according to claim 134, storing instructions wherein said execution environment provides a means to prevent a call stack overflow encountered during code execution, from halting a host operating system process.

139. The non-transitory computer-readable storage medium according to claim 134, storing instructions wherein said execution environment performs code execution against an installation selected from a group consisting of a version of a runtime system, a version of referenced libraries, a custom build of a runtime system, a custom build of referenced libraries, configuration of a runtime system, and configuration of referenced libraries, where at least one of said prohibited operations is modified to be unworkable, including being removed, being hidden and being modified with restricted capabilities.

140. The non-transitory computer-readable storage medium according to claim 134, storing instructions further comprising: equipping said execution environment with an installation selected from a group consisting of a version of a runtime system, a version of referenced libraries, a custom build of a runtime system, a custom build of referenced libraries, configuration of a runtime system, and configuration of referenced libraries, that checks for at least one of said prohibited operations, in real time, during code execution.

141. The non-transitory computer-readable storage medium according to claim 134, storing instructions wherein said execution environment provides a means to limit the amount of consumable memory during code execution.

142. The non-transitory computer-readable storage medium according to claim 134, storing instructions wherein said execution environment provides a means to limit the level of parallelism during code execution.

143. The non-transitory computer-readable storage medium according to claim 134, storing instructions further comprising: equipping said execution environment with an installation selected from a group consisting of a version of a runtime system, a version of referenced libraries, a custom build of a runtime system, a custom build of referenced libraries, configuration of a runtime system, and configuration of referenced libraries, where an implementation of at least one code construct including types, functions, methods, instructions and operations, is modified to improve operational safety during code execution.

144. The non-transitory computer-readable storage medium according to claim 134, storing instructions further comprising: equipping said execution environment with an installation selected from a group consisting of a version of a runtime system, a version of referenced libraries, a custom build of a runtime system, a custom build of referenced libraries, configuration of a runtime system, and configuration of referenced libraries, where at least one code construct including types, functions, methods, instructions and operations, that accesses a restricted system resource, is modified to limit the rate of concurrent access to the system resource.

145. The non-transitory computer-readable storage medium according to claim 134, storing instructions wherein the said set of prohibited operations is identified as an inverse or complement of a pre-identified set of permitted operations.

146. The non-transitory computer-readable storage medium according to claim 134, storing instructions wherein said execution environment performs processing, including compilations and transformations, on the code, after the code is received but before the code is executed.

147. The non-transitory computer-readable storage medium according to claim 146, storing instructions wherein said execution environment provides a means to detect at least one of said prohibited operations while performing said processing.

148. The non-transitory computer-readable storage medium according to claim 147, storing instructions wherein detection of a given operation as a prohibited operation, by said execution environment, is based on the presence of a construct associated with the given operation, in a predetermined list of constructs including types, functions, methods, keywords, instructions and operations.

149. The non-transitory computer-readable storage medium according to claim 147, storing instructions further comprising: performing an action, including halting the execution environment, according to a predetermined security policy on detection of at least one of said prohibited operations.

150. The non-transitory computer-readable storage medium according to claim 147, storing instructions further comprising: rewriting a detected prohibited operation into a safer form selected from a group consisting of unworkable forms, forms with limited capabilities, and safe alternative operations.

151. The non-transitory computer-readable storage medium according to claim 146, storing instructions wherein said execution environment injects new code or modifies provided code, during said processing, to improve operational safety during code execution.

152. The non-transitory computer-readable storage medium according to claim 134, storing instructions wherein detection of a given operation as a prohibited operation, by said analysis subsystem, is based on the presence of a construct associated with the given operation, in a predetermined list of constructs including types, functions, methods, keywords, instructions and operations.

153. The non-transitory computer-readable storage medium according to claim 152, storing instructions further comprising: inferring other constructs to be checked during detection, based on associations or references between available constructs and constructs in said predetermined list.

154. The non-transitory computer-readable storage medium according to claim 134, storing instructions wherein said analysis subsystem uses heuristics to inspect code and determine the possibility of the use of at least one of said prohibited operations.

155. The non-transitory computer-readable storage medium according to claim 134, storing instructions wherein said analysis subsystem detects operations that may potentially destabilize the runtime system.

156. The non-transitory computer-readable storage medium according to claim 134, storing instructions further comprising: injecting new code or modifying provided code by said analysis subsystem, to improve operational safety during code execution by said execution environment.

157. The non-transitory computer-readable storage medium according to claim 134, storing instructions wherein said analysis subsystem detects a prohibited operation and rewrites the operation into a safe alternative operation.

158. The non-transitory computer-readable storage medium according to claim 134, storing instructions wherein said analysis subsystem detects access to a restricted system resource and rewrites the code to use a different operation that accesses the system resource in a safe manner.

159. The non-transitory computer-readable storage medium according to claim 134, storing instructions wherein said analysis subsystem refers to a predetermined security policy to select an appropriate action to perform when code is determined to be unsafe.

160. A non-transitory computer-readable storage medium storing instructions that when executed by one or more computers cause the computers to perform a method comprising:
a. providing an execution environment that receives code, and executes the code;
b. specifying a security action to be performed, when said execution environment exhibits erroneous behavior that puts at risk the operational safety of a system selected from a group consisting of said execution environment, its network environment and its host environment; and
c. monitoring at least one instance of an execution environment for erroneous behavior, and performing said security action, if erroneous behavior is detected.

161. The non-transitory computer-readable storage medium according to claim 160, storing instructions further comprising:
a. identifying a set of prohibited operations, including access to types, field access, function calls, method calls, language keywords, syntax, instructions, and operations;
b. analyzing code, with an analysis subsystem, to detect use of at least one of said prohibited operations; and
c. communicating code analyzed by said analysis subsystem, to the execution environment, if the code is determined by the analysis subsystem to be satisfactory for execution.

162. The non-transitory computer-readable storage medium according to claim 160, storing instructions wherein said security action includes halting the execution environment.

163. The non-transitory computer-readable storage medium according to claim 160, storing instructions wherein said security action is derived from a predetermined security policy.

164. The non-transitory computer-readable storage medium according to claim 160, storing instructions wherein said monitoring involves monitoring the amount of time the execution environment spent executing code and performing said security action, if a time limit related threshold is crossed.

165. The non-transitory computer-readable storage medium according to claim 160, storing instructions wherein said monitoring involves monitoring memory consumption by the execution environment and performing said security action, if a memory size related threshold is crossed.

166. The non-transitory computer-readable storage medium according to claim 160, storing instructions wherein said monitoring involves monitoring the level of parallelism of the execution environment and performing said security action, if a parallelism level related threshold is exceeded.

167. The non-transitory computer-readable storage medium according to claim 160, storing instructions further comprising: monitoring at least one metric provided by a software system selected from a group consisting of a compiler, referenced libraries, runtime system, software container, operating system and virtualization provider, and performing said security action, if a metric related threshold is crossed.

168. The non-transitory computer-readable storage medium according to claim 160, storing instructions further comprising: monitoring operating system or virtualization provider resources, including network access, disk access and system calls, and performing said security action, if a resource related threshold is crossed.

169. The non-transitory computer-readable storage medium according to claim 160, storing instructions wherein said execution environment employs conventional security and sandboxing mechanisms provided by a software system selected from a group consisting of a compiler, referenced libraries, runtime system, software container, operating system and virtualization provider, to improve safety and security during code execution.

170. The non-transitory computer-readable storage medium according to claim 160, storing instructions further comprising: providing a means to isolate a memory address space accessible to an execution environment from memory address spaces accessible to other instances of execution environments.

171. The non-transitory computer-readable storage medium according to claim 160, storing instructions wherein said execution environment provides a means to prevent a call stack overflow encountered during code execution, from halting a host operating system process.

172. The non-transitory computer-readable storage medium according to claim 160, storing instructions further comprising:
a. identifying a set of prohibited operations, including access to types, field access, function calls, method calls, language keywords, syntax, instructions, and operations; and
b. equipping said execution environment with an installation selected from a group consisting of a version of a runtime system, a version of referenced libraries, a custom build of a runtime system, a custom build of referenced libraries, configuration of a runtime system, and configuration of referenced libraries, where at least one of said prohibited operations is modified to be unworkable, including being removed, being hidden and being modified with restricted capabilities.

173. The non-transitory computer-readable storage medium according to claim 160, storing instructions further comprising:
a. identifying a set of prohibited operations, including access to types, field access, function calls, method calls, language keywords, syntax, instructions, and operations; and
b. equipping said execution environment with an installation selected from a group consisting of a version of a runtime system, a version of referenced libraries, a custom build of a runtime system, a custom build of referenced libraries, configuration of a runtime system, and configuration of referenced libraries, that checks for at least one of said prohibited operations, in real time, during code execution.

174. The non-transitory computer-readable storage medium according to claim 160, storing instructions wherein said execution environment provides a means to limit the amount of consumable memory during code execution.

175. The non-transitory computer-readable storage medium according to claim 160, storing instructions wherein said execution environment provides a means to limit the level of parallelism during code execution.

176. The non-transitory computer-readable storage medium according to claim 160, storing instructions further comprising: equipping said execution environment with an installation selected from a group consisting of a version of a runtime system, a version of referenced libraries, a custom build of a runtime system, a custom build of referenced libraries, configuration of a runtime system, and configuration of referenced libraries, where an implementation of at least one code construct including types, functions, methods, instructions and operations, is modified to improve operational safety during code execution.

177. The non-transitory computer-readable storage medium according to claim 160, storing instructions further comprising: equipping said execution environment with an installation selected from a group consisting of a version of a runtime system, a version of referenced libraries, a custom build of a runtime system, a custom build of referenced libraries, configuration of a runtime system, and configuration of referenced libraries, where at least one code construct including types, functions, methods, instructions and operations, that accesses a restricted system resource, is modified to limit the rate of concurrent access to the system resource.

178. The non-transitory computer-readable storage medium according to claim 160, storing instructions wherein said execution environment performs processing, including compilations and transformations, on the code, after the code is received but before the code is executed.

179. The non-transitory computer-readable storage medium according to claim 178, storing instructions further comprising:
a. identifying a set of prohibited operations, including access to types, field access, function calls, method calls, language keywords, syntax, instructions, and operations; and
b. providing a means for said execution environment to detect at least one of said prohibited operations while performing said processing.

180. The non-transitory computer-readable storage medium according to claim 179, storing instructions wherein the said set of prohibited operations is identified as an inverse or complement of a pre-identified set of permitted operations.

181. The non-transitory computer-readable storage medium according to claim 179, storing instructions wherein detection of a given operation as a prohibited operation, by said execution environment, is based on the presence of a construct associated with the given operation, in a predetermined list of constructs including types, functions, methods, keywords, instructions and operations.

182. The non-transitory computer-readable storage medium according to claim 179, storing instructions further comprising: performing an action, including halting the execution environment, according to a predetermined security policy on detection of at least one of said prohibited operations.

183. The non-transitory computer-readable storage medium according to claim 179, storing instructions further comprising: rewriting a detected prohibited operation into a safer form selected from a group consisting of unworkable forms, forms with limited capabilities, and safe alternative operations.

184. The non-transitory computer-readable storage medium according to claim 178, storing instructions wherein said execution environment injects new code or modifies provided code, during said processing, to improve operational safety during code execution.

185. A non-transitory computer-readable storage medium storing instructions that when executed by one or more computers cause the computers to perform a method comprising:
a. providing an execution environment that receives code, and executes the code;
b. identifying a set of prohibited operations, including access to types, field access, function calls, method calls, language keywords, syntax, instructions, and operations; and
c. providing a means for said execution environment to analyze code and detect use of at least one of said prohibited operations.

186. The non-transitory computer-readable storage medium according to claim 185, storing instructions wherein said execution environment employs conventional security and sandboxing mechanisms provided by a software system selected from a group consisting of a compiler, referenced libraries, runtime system, software container, operating system and virtualization provider, to improve safety and security during code execution.

187. The non-transitory computer-readable storage medium according to claim 185, storing instructions further comprising: providing a means to isolate a memory address space accessible to an execution environment from memory address spaces accessible to other instances of execution environments.

188. The non-transitory computer-readable storage medium according to claim 185, storing instructions wherein said execution environment provides a means to prevent a call stack overflow encountered during code execution, from halting a host operating system process.

189. The non-transitory computer-readable storage medium according to claim 185, storing instructions wherein said execution environment performs code execution against an installation selected from a group consisting of a version of a runtime system, a version of referenced libraries, a custom build of a runtime system, a custom build of referenced libraries, configuration of a runtime system, and configuration of referenced libraries, where at least one of said prohibited operations is modified to be unworkable, including being removed, being hidden and being modified with restricted capabilities.

190. The non-transitory computer-readable storage medium according to claim 185, storing instructions further comprising: equipping said execution environment with an installation selected from a group consisting of a version of a runtime system, a version of referenced libraries, a custom build of a runtime system, a custom build of referenced libraries, configuration of a runtime system, and configuration of referenced libraries, that checks for at least one of said prohibited operations, in real time, during code execution.

191. The non-transitory computer-readable storage medium according to claim 185, storing instructions wherein said execution environment provides a means to limit the amount of consumable memory during code execution.

192. The non-transitory computer-readable storage medium according to claim 185, storing instructions wherein said execution environment provides a means to limit the level of parallelism during code execution.

193. The non-transitory computer-readable storage medium according to claim 185, storing instructions further comprising: equipping said execution environment with an installation selected from a group consisting of a version of a runtime system, a version of referenced libraries, a custom build of a runtime system, a custom build of referenced libraries, configuration of a runtime system, and configuration of referenced libraries, where an implementation of at least one code construct including types, functions, methods, instructions and operations, is modified to improve operational safety during code execution.

194. The non-transitory computer-readable storage medium according to claim 185, storing instructions further comprising: equipping said execution environment with an installation selected from a group consisting of a version of a runtime system, a version of referenced libraries, a custom build of a runtime system, a custom build of referenced libraries, configuration of a runtime system, and configuration of referenced libraries, where at least one code construct including types, functions, methods, instructions and operations, that accesses a restricted system resource, is modified to limit the rate of concurrent access to the system resource.

195. The non-transitory computer-readable storage medium according to claim 185, storing instructions wherein the said set of prohibited operations is identified as an inverse or complement of a pre-identified set of permitted operations.

196. The non-transitory computer-readable storage medium according to claim 185, storing instructions wherein detection of a given operation as a prohibited operation, by said execution environment, is based on the presence of a construct associated with the given operation, in a predetermined list of constructs including types, functions, methods, keywords, instructions and operations.

197. The non-transitory computer-readable storage medium according to claim 185, storing instructions further comprising: performing an action, including halting the execution environment, according to a predetermined security policy on detection of at least one of said prohibited operations.

198. The non-transitory computer-readable storage medium according to claim 185, storing instructions further comprising: rewriting a detected prohibited operation into a safer form selected from a group consisting of unworkable forms, forms with limited capabilities, and safe alternative operations.

199. The non-transitory computer-readable storage medium according to claim 185, storing instructions wherein said execution environment performs processing, including compilations and transformations, on the code, after the code is received but before the code is executed.

200. The non-transitory computer-readable storage medium according to claim 199, storing instructions wherein said execution environment injects new code or modifies provided code, during said processing, to improve operational safety during code execution.
